(19) United States
(12) Patent Application Publication
(10) Pub. No.: US 2005/0122577 A1
(43) Pub. Date: Jun. 9, 2005

(54) Confocal microscope and measuring method by this confocal microscope

(75) Inventors: Hirohisa Fujimoto, Hachioji-shi (JP); Akihiro Kitahara, Hachioji-shi (JP); Nobuhiro Kita, Hachioji-shi (JP); Hideo Watanabe, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 11/015,076

(22) Filed: Dec. 16, 2004

Related U.S. Application Data
(63) Continuation of application No. PCT/JP03/07750, filed on Jun. 18, 2003.

(30) Foreign Application Priority Data
Jun. 18, 2002 (JP) 2002-177047
Jun. 18, 2002 (JP) 2002-177472
Sep. 9, 2002 (JP) 2002-263033
Sep. 18, 2002 (JP) 2002-272246

(51) Int. Cl. G02B 21/06

(52) U.S. Cl. 359/383; 359/368

(57) ABSTRACT

The present invention relates to a confocal microscope and a measuring method by the confocal microscope in which one or a plurality of measuring units to detect a movement amount are disposed facing a Z-stage having a sample laid thereon, the measuring unit detects a relative position between a condensing position of an objective lens and the sample, a maximum value of a change curved line indicated by light intensity information, and a relative position giving this value are estimated based on obtained relative position information, and a plurality of pieces of light intensity information including the maximum light intensity value of the light intensity, and a confocal image is produced using the estimated maximum value of the light intensity and the relative position as reflection luminance information and height information.

### CROSS-REFERENCE TO RELATED APPLICATIONS

This is a Continuation Application of PCT Application No. PCT/JP03/07750, filed Jun. 18, 2003, which was not published under PCT Article 21(2) in English.

This application is based upon and claims the benefit of priority from prior Japanese Patent Applications No. 2002-177047, filed Jun. 18, 2002; No. 2002-177472, filed Jun. 18, 2002; No. 2002-263033, filed Sep. 9, 2002; and No. 2002-272246, filed Sep. 18, 2002, the entire contents of all of which are incorporated herein by reference.

### BACKGROUND OF THE INVENTION

1. Field of the Invention

The present invention relates to a confocal microscope which applies light to a sample and which measures surface information of a sample from reflected light, and a measuring method by this confocal-microscope.

2. Description of the Related Art

In general, in a confocal microscope, spot illumination is applied to a sample, light from the sample, for example, transmitted or reflected light is condensed on a confocal diaphragm, and thereafter intensity of the light transmitted through this confocal diaphragm is detected by a photodetector to thereby acquire surface information of the sample. The spot illumination is scanned over a sample surface by various methods, and the surface information of a broad range of the sample is acquired from the obtained light intensity.

FIG. 19 shows one constitution example of a conventional confocal microscope. In the confocal microscope, light emitted from a light source 71 passes through a beam splitter 72, thereafter enters a two-dimensional scanning mechanism 74 via a reflective mirror 73, and is two-dimensionally scanned. This two-dimensionally scanned light is condensed by an objective lens 75, and applied onto a sample 77 laid on a sample base 76.

The reflected light from the surface of the sample 77 is guided again into the objective lens 75, and strikes on the beam splitter 72 via the two-dimensional scanning mechanism 74 and the reflective mirror 73. The reflected light is guided to a reflected light path of the beam splitter 72, bent on the side of an image forming lens 78, and condensed onto a confocal diaphragm 79. The confocal diaphragm 79 is disposed in a position conjugated with the objective lens 75, and passes the only light of a condensing point of the sample 77 to a photodetector 80. The photodetector 80 detects light intensity (hereinafter referred to as the detected value) of the light only of this condensing point.

The sample base 76 is disposed on a Z-stage 81, and moved/controlled in an optical axis direction by this Z-stage 81. A process control unit 82 is comprised of a computer, drives/controls microscope components including the Z-stage 81, two-dimensional scanning mechanism 74, photodetector 80 and the like in accordance with a preset control program, and displays an operation state or an instruction for an operation in a monitor 83.

The condensed position by the above-described objective lens 75 is disposed in a position optically conjugated with the confocal diaphragm 79. Accordingly, when the sample 77 is in the condensed position by the objective lens 75, the reflected light from the sample 77 is condensed on the confocal diaphragm 79, and passes through the confocal diaphragm 79. Moreover, when the sample 77 is in a position deviating from the condensed position by the objective lens 75, the reflected light from the sample 77 is not condensed onto the confocal diaphragm 79, and hardly passes through the diaphragm.

In a relation between a relative position (Z) of the objective lens 75 with respect to the sample 77 and a detected value (I) output from the photodetector 80, referred to as an I-Z curve obtained by this constitution, this detected value is maximum in a case where the sample 77 is in a condensed position Z0 of the objective lens 75 as shown in FIG. 20. There is a characteristic that the detected value of the photodetector 80 steeply drops as the relative position between the objective lens 75 and the sample 77 is distant from this condensed position Z0.

The process control unit 82 two-dimensionally scans the condensed point by the two-dimensional scanning mechanism 74 to thereby irradiate the sample 77 utilizing this characteristic, and the detected value of the photodetector 80 is formed into an image in synchronization with the two-dimensional scanning mechanism 74 to thereby acquire an image (confocal image) obtained by optically slicing the sample 77.

Moreover, the sample 77 is moved in the optical axis direction by the Z-stage 81, the two-dimensional scanning mechanism 74 is scanned in each position to acquire the confocal image, the position of the Z-stage 81 in which the detected value of the photodetector 80 is maximum is detected in each point on the sample 77, and accordingly height information of the sample 77 is acquired.

Furthermore, a maximum value of the detected value of the photodetector 80 is superimposed and displayed in each point of the sample 77, and accordingly focused images are acquired on all surfaces.

In the confocal microscope, the confocal image is formed, and accordingly a height of the sample 77 can be measured. When measurement precision is raised in this case, a width by which the Z-stage 81 is moved once, that is, a detection step width (or the movement pitch) is reduced, and therefore the number of measurement times of this detection occupies the greater part of a time required until the condensed position Z0 is detected.

As improvement of this, for example, in Jpn. Pat. Appln. KOKAI Publication No. 09-068413, a measuring method has been proposed in which precision of height measurement of the sample 77 is enhanced without narrowing the detection step width of the Z-stage 81. In this measuring method, the I-Z curve is approximated by a two-dimensional curved line based on the position Z0 of the Z-stage 81 in which the value is maximum, and detected values (light intensities) of three points in total in a forward/backward position from the photodetector 80, the position of the Z-stage 81 in which the detected value of the photodetector 80 is maximum is obtained with a precision which is not more than the movement pitch of the conventional Z-stage 81, and the height information is obtained.

For example, three detected values are obtained as shown by black circles in FIG. 21A. It can be assumed that an approximate secondary curved line (approximated I-Z curve) (solid line shown in FIG. 21A) obtained using these three detected values is substantially equal to an actual I-Z curve (dot line of FIG. 12A) in a practical range, and a maximum value Imax at which the detected value of the photodetector 80 is maximum, and a position Zo of the Z-stage 81 at this time can be correctly estimated from this approximate secondary curved line.

However, in the measuring method by the above-described Jpn. Pat. Appln. KOKAI Publication No. 9-68413, the I-Z curve steeply changes in the vicinity of the condensing position of the objective lens 75 as shown in FIG. 20. Therefore, to drive the Z-stage 81 in the optical axis direction, there is a problem that a correct approximate curved line cannot be obtained unless a Z-axis is moved to a correct position in accordance with an instruction from the process control unit 82. Especially, when the number of the detected values of the light intensity is reduced to three points or the like, an error increases. Therefore, the Z-stage 81 has to be driven/controlled at a high precision and high resolution, and this is a burden on an operator.

Moreover, when a relative movement pitch in a Z-axis is in a fixed state, a portion having little change of the detected value in the vicinity of a peak of the I-Z curve is sampled, and therefore noises have large influences. A calculation process is performed even with respect to the detected value from a position (spread portion) of the Z-stage 81 which is not important, therefore the number of data is large, and time is required for calculating the approximate two-dimensional curved line.

Moreover, measurement conditions for obtaining the position of the Z-stage 81 in which the value is maximized, that is, the number of light intensity detected values for use in approximation, an approximate curved line for use, and the width (relative movement pitch) of the detection step between the condensed position and the sample need to be set by a user. For example, the number of the light intensity detected values has to be set to three, a two-dimensional curved line has to be set as an approximate curved line, and a relative movement pitch or the like has to be designated.

Since this I-Z curve is set to be different depending on a magnification or the like of the objective lens 75, it is not easy to select an optimum relative movement pitch. Furthermore, the measurement conditions differ depending on whether the height of the sample is measured at a high speed or with a high precision, but the measurement conditions are not considered in the technique described in the above-described publication.

Moreover, strong/weak contrast is generated based on non-uniformity of reflectance of the sample surface, and portions lacking in the detected light intensity or having excessively intense light are easily mixed.

For example, when the light intensity is lacking as shown by black circles of FIG. 21B, one of the detected values of the photodetector 80 in three Z positions sometimes indicates 0 which is a minimum value. The approximate two-dimensional curved line (solid line shown in FIG. 21B) obtained using these three detected values of the photodetector 80 is different from the actual I-Z curve (dotted line shown in FIG. 21B), and Imax and Zo to be originally estimated from the obtained approximate two-dimensional curved line indicate values deviating by Ierr, Zerr, respectively.

Conversely, when the light intensity is excessively strong, the value sometimes exceeds a detection range of the photodetector 80, for example, as in a detected value shown by a white circle of FIG. 21C. The detected value exceeding the detection range indicates a detected value shown by a black circle (middle) replaced with 4095 (additionally, in case of a 12 bit range) which is a maximum value regardless of the actual value. The approximate two-dimensional curved line (solid line shown in FIG. 21C) obtained using these detected values is different from the actual I-Z curve (dotted line shown in FIG. 21C). The Imax to be originally estimated from the obtained approximate two-dimensional curved line exceeds a predicted maximum value, and Zo indicates a value deviating by Zerr. When any of these three detected values indicates a minimum or maximum value in a range that can be taken by the detected values of the photodetector 80, the approximate two-dimensional curved line cannot be obtained.

Moreover, in portions in the vicinity of opposite ends of a preset scanning range of the Z-stage 81, only two detected values are obtained in some case, for example, as shown by black circles of FIG. 21D.

Even if one missing detected value is appropriately compensated (e.g., a white circle of FIG. 21D) to obtain the approximate two-dimensional curved line (solid line shown by FIG. 21D), it is not seen whether or not the curved line matches the actual I-Z curve (dotted line of FIG. 21D). Therefore, Imax and Zo estimated by the appropriately compensated detected values change in any manner, and correct values cannot be estimated.

When the height is measured based on the approximated I-Z curve in this manner, obtained luminance and height information sometimes include uncertain measurement results as shown in FIGS. 21B to 21D or the like. Even if the result is included, the user does not have any measure to known that.

### BRIEF SUMMARY OF THE INVENTION

An object of the present invention is to provide a confocal microscope and a measuring method by this confocal microscope, capable of calculating an approximate equation at a high speed and with a high precision on optimum measurement conditions by a simple constitution and realizing acquisition of a confocal image.

According to the present invention, to achieve the above-described object, there is provided a confocal microscope comprising: an objective lens which condenses and applies light from a light source with respect to a sample and which takes in reflected light from the sample; a moving mechanism which relatively moves a condensing position of the objective lens and a position of the sample along an optical axis direction of the light; a confocal diaphragm disposed in a position conjugated with the condensing position of the objective lens; a photodetector which detects intensity of the light passing through the confocal diaphragm; a measuring unit which detects a relative position between the condensing position of the objective lens, and the sample; and a process control unit which changes the relative position between the condensing position of the objective lens, and the sample and which estimates a maximum value of a change curved line indicated by light intensity information and the relative position giving the value based on a plurality of pieces of light intensity information including a maximum light intensity value of the light intensity detected by the photodetector and position information detected by the measuring unit and which produces a confocal image using the estimated maximum value of the light intensity and the relative position as reflection luminance information and height information.

Furthermore, according to the present invention, there is provided a confocal microscope comprising: an objective lens; a confocal diaphragm disposed in a position conjugated with a condensing position of the objective lens; a photodetector which acquires light intensity information passed through the confocal diaphragm in a discrete manner at a time when a relative distance between the sample and the objective lens is changed; a relative distance estimation unit which estimates the relative distance to obtain maximum light intensity information based on these light intensity information; and a height information calculation unit which has measurement condition data of the light intensity information in accordance with each measurement mode to acquire a magnification of the objective lens and the height information and which changes the relative distance between the sample and the objective lens in accordance with the measurement condition data to acquire the height information of the sample.

Moreover, there is provided height measuring method using a confocal scanning type optical microscope, the measuring method by a confocal microscope, comprising: changing a relative position between a sample and an objective lens at a predetermined interval, while measuring luminance in a plurality of positions; evaluating an influence of a noise using luminance data in positions of at least three continuous points including the maximum luminance among measurement results of the luminance in the plurality of positions; and obtaining an approximate curved line to calculate a peak position of the luminance based on the evaluation results of the noise.

### BRIEF DESCRIPTION OF THE SEVERAL VIEWS OF THE DRAWING

FIG. 1 is a diagram showing a constitution of a confocal microscope according to a first embodiment of the present invention;

FIG. 2 is an explanatory view of a process operation to produce a confocal image in the confocal microscope of FIG. 1;

FIG. 3 is a diagram showing a constitution of the confocal microscope according to a second embodiment of the present invention;

FIG. 4 is a diagram showing a constitution of the confocal microscope according to a third embodiment of the present invention;

FIG. 5 is a diagram schematically showing measurement condition data in the third embodiment;

FIG. 6 is a diagram showing a setting screen in the third embodiment;

FIG. 7 is a diagram showing a schematic constitution of a confocal microscope system applied to a height measuring method according to a fourth embodiment of the present invention;

FIG. 8 is a flowchart showing the height measuring method in the fourth embodiment;

FIG. 9 is a characteristic diagram showing the height measuring method in the fourth embodiment;

FIG. 10 is a diagram showing a constitution of the confocal microscope according to a fifth embodiment of the present invention;

FIG. 11 is a diagram showing a relation (I-Z curve) between relative position (Z) of a condensed position of an objective lens with respect to a sample in the fifth embodiment, and an output (I) of a photodetector;

FIGS. 12A, 12B, 12C are diagrams showing examples of an output of the photodetector in three extracted Z positions in the fifth embodiment;

FIGS. 13A, 13B, 13C are diagrams showing one example of a shape of the sample in the fifth embodiment, FIG. 13B is a diagram showing one example of a luminance image (two-dimensional image) displayed based on acquired luminance, and FIG. 13C is a diagram showing one example of a height image (three-dimensional image) displayed based on an acquired luminance and height;

FIG. 14 is a diagram showing a measurement range in a Z direction set by a user;

FIG. 15 is a diagram showing one example of a data format according to a sixth embodiment of the present invention;

FIG. 16A is a diagram showing one example of a luminance image (two-dimensional image) displayed in accordance with values of flags of bits having bit numbers 12 to 14, and FIG. 16B is a diagram showing one example of a height image (three-dimensional image) displayed in accordance with the values of the flags of the bits having bit numbers 12 to 14;

FIG. 17A is a diagram showing and displaying the luminance image shown in FIG. 16A together with occupying ratios of measurement points colored in colors in a whole, and FIG. 17B is a diagram showing the height image shown in FIG. 16B together with occupying ratios of measurement points colored in colors in a whole;

FIG. 18 is a diagram showing a display example of a measurement result in a sixth embodiment;

FIG. 19 is a diagram showing a constitution of a conventional confocal microscope;

FIG. 20 is a diagram showing a process operation to produce a conventional confocal image; and

FIGS. 21A to 21D are diagrams showing examples of acquired outputs of a photodetector in three Z positions.

### DETAILED DESCRIPTION OF THE INVENTION

Embodiments of the present invention will be described hereinafter in detail.

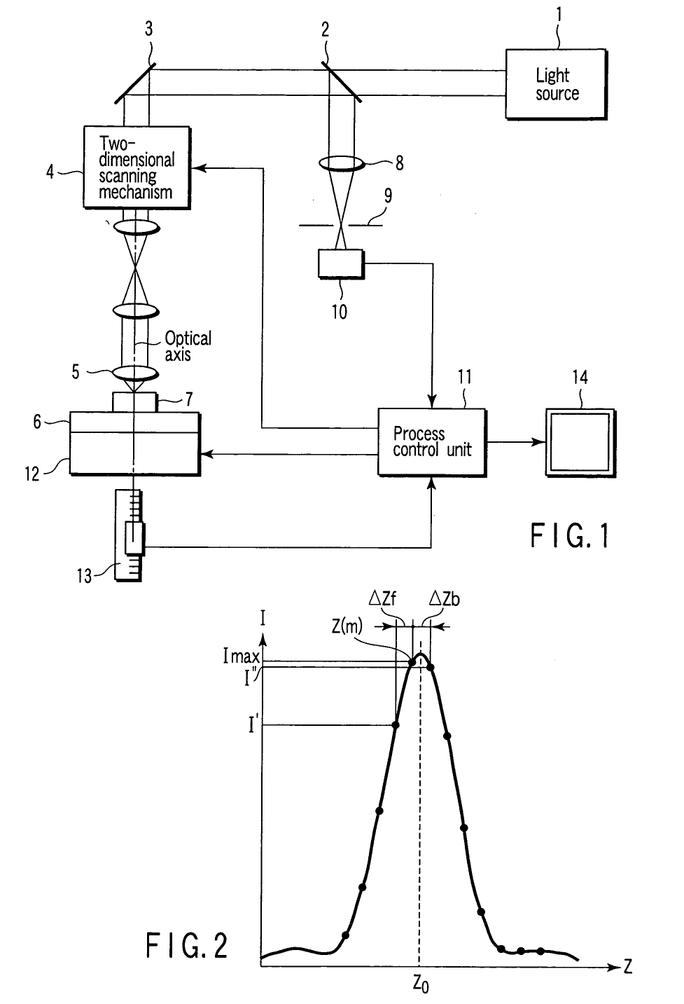

FIG. 1 is a diagram schematically showing a constitution of a confocal microscope according to a first embodiment of the present invention.

In this confocal microscope, light emitted from a light source 1 passes through a beam splitter 2, and thereafter enters a two-dimensional scanning mechanism 4 via a reflective mirror 3. The light two-dimensionally scanned by the two-dimensional scanning mechanism 4 is condensed by an objective lens 5, and applied to a sample 7 laid on a sample base 6.

Reflected light reflected by a condensing point on the surface of the sample 7 is guided to the objective lens 5 again, and strikes on the beam splitter 2 via the two-dimensional scanning mechanism 4 and the reflective mirror 3. This beam splitter 2 guides the reflected light to a reflected light path, and the light is condensed onto a confocal diaphragm 9 by an image forming lens 8. The confocal diaphragm 9 is disposed in a position conjugated with the objective lens 5, cuts the reflected light from the sample 7 except the condensing point, and passes the only reflected light from the condensing point through a photodetector 10. This photodetector 10 detects light intensity of the condensing point passed through the confocal diaphragm 9 as a detection signal, and sends the signal to a process control unit 11 comprising a computer including a CPU and the like.

Here, a condensed position by the objective lens 5 is optically conjugated with a position of the confocal diaphragm 9. Therefore, when the sample 7 is in the condensed position by the objective lens 5, the reflected light from the sample 7 is condensed on the confocal diaphragm 9, and passes through the confocal diaphragm 9. Moreover, when the sample 7 is in a position deviating from the condensed position by the objective lens 5, the reflected light from the sample 7 is condensed on the confocal diaphragm 9 and is brought into a spread state, and the light only slightly passes through the confocal diaphragm 9.

Moreover, the sample base 6 is mounted on a Z-stage 12, and moved/driven in an optical axis direction by the Z-stage 12. A measuring unit 13 such as a glass scale constituting measurement means is disposed facing the Z-stage 12 on an optical axis. A movement pitch in a Z-direction which is a relative position between the objective lens 5 and the sample 7 is detected by the measuring unit 13. Moreover, this measuring unit 13 outputs an obtained detection signal to the process control unit 11.

The value (Z) that the measuring unit 13 obtained is maximal when the sample 7 lies at the focal point Z0 of the objective lens 5, as can be understood from the I-Z curve shown in FIG. 2, which represents the relation between the value (Z) and the output (I) of the photodetector 10. The value (Z) abruptly decreases as the sample 7 moves away from the focal point z0 of the objective lens.

Moreover, the process control unit 11 is connected to the Z-stage 12, two-dimensional scanning mechanism 4, and photodetector 10 together with the measuring unit 13, and drives/controls each microscope components including the Z-stage 12, two-dimensional scanning mechanism 4 and the like in accordance with a control program stored beforehand based on outputs of the photodetector 10 and measuring unit 13. In this case, the process control unit 11 displays an operation screen in a monitor 14.

By this constitution, the process control unit 11 drives/controls the two-dimensional scanning mechanism 4 to two-dimensionally scan a condensing point on the sample 7, and processes the output of the photodetector 10 into an image in synchronization with the two-dimensional scanning mechanism 4. Accordingly, the unit forms an only specific height of the sample 7 into the image, and produces an image (confocal image) obtained by optically slicing the sample 7. This image is displayed together with the above-described operation screen in the monitor 14.

That is, luminance and height calculation program are stored beforehand in the process control unit 11. An approximate curved line is set in the luminance and the calculation program in accordance with an I-Z curve for each objective lens 5. The process control unit 11 starts measurement of the measuring unit 13, moves the Z-stage 12 at a determined movement pitch ΔZ in a measurement range, and produces sliced confocal images for each Z relative position accompanying the movement.

Here, light intensity information are values on the I-Z curve shown by black circles in FIG. 2, points are compared with one another, and, for example, values (Zm-ΔZf, I′), (Zm+ΔZb, I″) before/after a maximum intensity (Zm, Imax) are extracted. The luminance and relative height of the surface of the sample 7 are obtained from the three points based on an approximate curved line with a resolution which is not less than the movement pitch ΔZ. The process control unit 11 produces the confocal image based on the luminance and relative height information of the surface of the sample 7, estimated in this manner.

Since the movement pitch ΔZ of the Z-stage 12 is actually measured by the measuring unit 13, a correct moving operation is not obtained as in a conventional technique, and it is not necessary to dispose a detection position at an equal interval for each movement pitch. Therefore, even when a moving mechanism having a simple constitution is disposed, a high-precision image can be produced. It is to be noted that in a case where the detection positions are not arranged at the equal interval, correction is made in accordance with the arrangement, and accordingly a desired measurement precision is secured.

Thus, in the confocal microscope, the measuring unit 13 for detecting a movement amount is disposed facing the Z-stage 12. The measuring unit 13 detects a relative position between the condensing position of the objective lens 5 and the sample 7. The microscope estimates a maximum value of a change curve indicated by the light intensity information, and the relative position giving the value based on the detected relative position information, and a plurality of pieces of light intensity information including a maximum light intensity value of light intensity. The confocal image is produced using the estimated maximum value of the light intensity and the relative position as reflection luminance information and height information.

Therefore, when the luminance and height dimension of the sample 7 are acquired based on relative position information (movement information of the Z-stage 12) detected by the measuring unit 13, the condensing position of the objective lens 5 and the position of the sample 7 do not have to be moved with high precision. Moreover, the number of movements of the Z-stage 12 can be kept to be minimum, and quick calculation is possible.

Moreover, according to this, since the relative position between the condensing position of the objective lens 5 and the sample 7 is detected using the measuring unit 13, high-precision detection of the moved positions is realized without being influenced by a moving performance of the Z-stage 12, and accordingly the moving mechanism to control the movement of the Z-stage 12 is simplified.

It is to be noted that in the present embodiment, an example of the measuring unit 13 comprising a glass scale has been described, but the present invention is not limited to this, and a measuring unit to measure various lengths, such as a laser interferometer or the like, may be used and constituted.

Moreover, in the first embodiment, an example in which the sample 7 is moved in a Z-direction (optical axis direction) and constituted to be relatively moved with respect to the objective lens 5, but the present invention is not limited to this, and the whole microscope may be moved with respect to the sample 7, or the objective lens 5 may be constituted to be relatively moved with respect to the sample 7. In any constitution, a substantially similar effect can be obtained.

As described above in detail, according to the confocal microscope of the first embodiment, a high-precision confocal image can be simply and easily acquired with a simple constitution.

Furthermore, in the first embodiment, as a method of calculating the reflection luminance and height dimension, it has been described that an approximate curved line is defined as a two-dimensional curved line, and the number of calculation points is set to three points, but the present invention is not limited to this, and various calculating methods may be constituted in accordance with device characteristics.

Next, a confocal microscope of a second embodiment will be described.

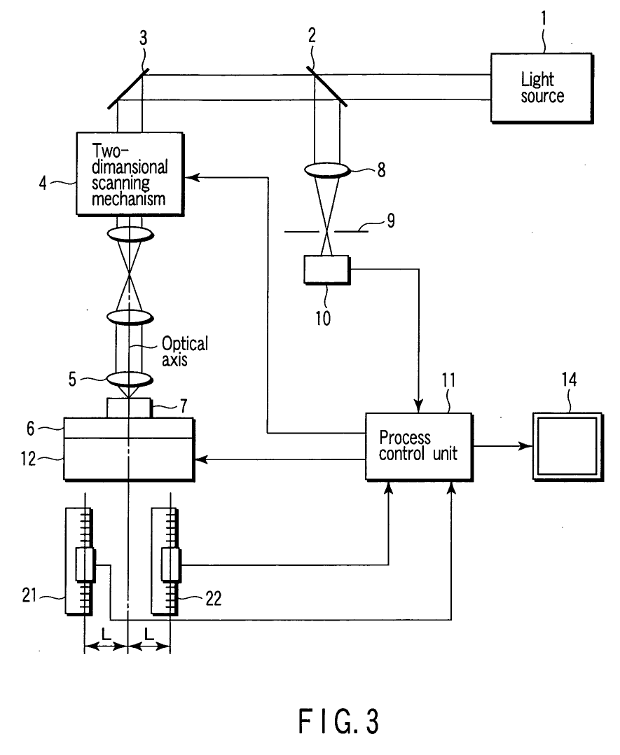

The above-described embodiment has been an example in which one measuring unit is used, but in the present embodiment, a plurality of measuring units are used as shown in FIG. 3. It is to be noted that constituting portions shown in FIG. 3, equivalent to those shown in FIG. 1 described above, are denoted with the same reference numerals, and description thereof is omitted.

In this confocal microscope, for example, two measuring units 21, 22 are substantially symmetrically arranged with respect to an optical axis of the objective lens 5 at an interval L, and these measuring units 21, 22 are constituted in such a manner as to measure a relative position between a condensed position of an objective lens 5, and a sample 7.

In this constitution, measured values of two measuring units 21, 22 arranged substantially symmetrically with respect to the optical axis of the objective lens 5 at the interval L are averaged to obtain reflection luminance and height dimension, and a confocal image is similarly produced based on the averaged and obtained reflection luminance and height dimension.

According to the confocal microscope of the second embodiment, a movement pitch in a Z-direction can be measured by two measuring units, and a confocal image having a precision higher than that of the first embodiment can be easily acquired with a simple constitution.

Next, a confocal microscope according to a third embodiment of the present invention will be described.

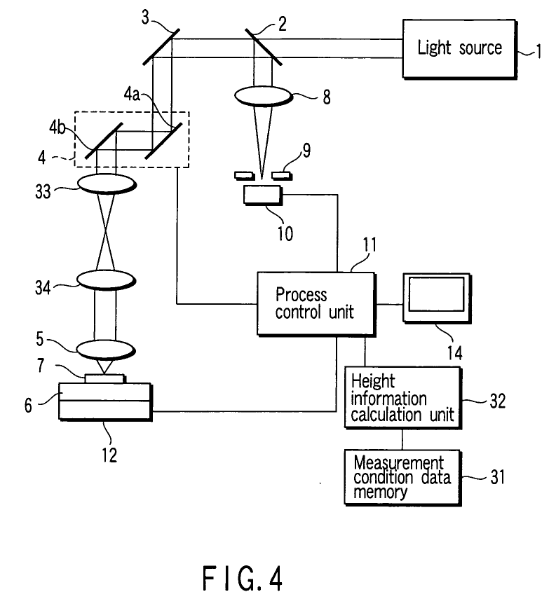

FIG. 4 is a diagram schematically showing a constitution of the confocal microscope of the third embodiment. It is to be noted that constituting portions shown in FIG. 4, equivalent to those shown in FIG. 1 described above, are denoted with the same reference numerals, and description thereof is omitted.

In this confocal microscope, a process control unit 11 has a series of operation control program of operating/controlling a two-dimensional scanning mechanism 4 and a Z-stage 12, taking in an output of a photodetector 10 to acquire light intensity information in a discrete manner, estimating a relative distance to obtain maximum light intensity information based on the light intensity information, and obtaining this relative distance as height information of a sample 7, and additionally has a luminance and height calculation program.

The process control unit 11 has a height information calculation unit 32. The height information calculation unit 32 comprises a measurement condition data memory 31 to store measurement condition data of light intensity information in accordance with each measurement mode in which luminance and height are calculated as described later to thereby acquire magnification and height information of an objective lens 5. This height information calculation unit 32 reads the measurement condition data from the measurement condition data memory 31, and changes a relative distance between the sample 7 and the objective lens 5 in accordance with the measurement condition data to acquire height information of the sample 7.

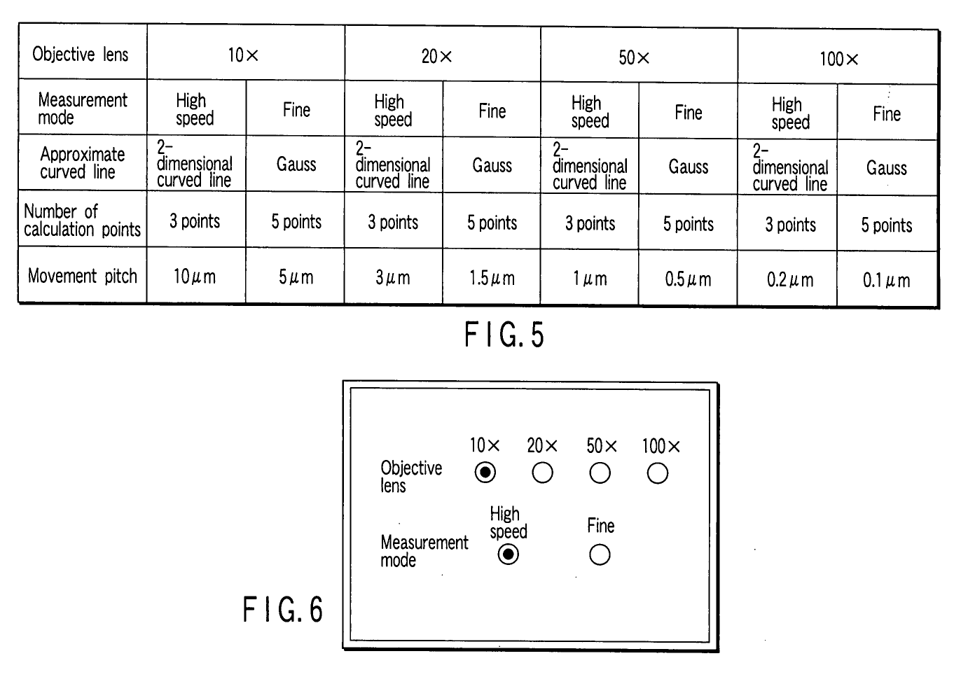

FIG. 5 is a schematic diagram showing one example of measurement condition data stored in the measurement condition data memory 31. As to the measurement condition data, for example, 10 times, 20 times, 50 times, and 100 times are stored as magnifications of the objective lens 5, and measurement modes, for example, a high-speed mode and a fine mode are stored with respect to the magnifications of the objective lens 5. The high-speed mode is a mode in which a measurement time of height information of the sample 7 is given priority, and the fine mode is a mode in which a measurement precision of the height information of the sample 7 is given priority.

In these high-speed mode and fine mode, data are stored including an approximate curved line for estimating the height information from the light intensity information in accordance with the magnification of the objective lens 5 and the measurement mode, the number of calculation points to extract the light intensity information from the approximate curved line, and a movement pitch ΔZ at a time when the relative distance is changed.

Among the data, a two-dimensional curved line is stored in the high-speed mode, and a gauss curved line is stored in the fine mode in the approximate curved line, and three points are stored in the high-speed mode, and five points are stored in the fine mode in the number of the calculation points. In the movement pitch ΔZ, different movement pitches ΔZ are stored with respect to the high-speed mode and the fine mode in the magnifications of the objective lens 5. For example, 10 μm is stored with respect to the high-speed mode, for example, in the objective lens 5 having a magnification of 10 times, and 5 μm or the like is stored with respect to the fine mode.

Moreover, the process control unit 11 has a function of displaying the confocal image of the sample 7 in the monitor 14, and displaying an operation screen (not shown) for acquiring the height information of the sample 7 together with the confocal image in the monitor 14. Furthermore, the process control unit 11 has a function of displaying a setting screen for executing the luminance and height calculation program to thereby perform selection of the magnification (e.g., 10 times, 20 times, 50 times, 100 times) of the objective lens 5 shown in, for example, in FIG. 5 and selection of the measurement mode (e.g., the high-speed mode, the fine mode) on a screen of the monitor 14.

Next, an operation of a confocal microscope device constituted in this manner will be described.

A luminous flux emitted from the light source 1 is transmitted through the beam splitter 2, and reflected by the mirror 3 to enter the two-dimensional scanning mechanism 4. This two-dimensional scanning mechanism 4 two-dimensionally scans the luminous flux which has struck on the first and second light scanners 4a, 4b. The luminous flux two-dimensionally scanned by this two-dimensional scanning mechanism 4 enters the objective lens 5 through lenses 33, 34. The luminous flux which has entered the objective lens 5 is formed into convergent light by the objective lens 5, and scanned over the surface of the sample 7.

The light reflected by the surface of the sample 7 passes through a light path reverse to an incident light path onto the sample 7, that is, passes through the respective lenses 34, 33 from the objective lens 5, and further passes through the two-dimensional scanning mechanism 4 and the reflective mirror 3 to enter the beam splitter 2 again. The light which has entered the beam splitter 2 again is reflected by the beam splitter 2, and condensed onto the confocal diaphragm 9 by the image forming lens 8. The photodetector 10 receives the luminous flux passed through the confocal diaphragm 9, and outputs an electric signal.

The process control unit 11 takes in the output of the photodetector 10 in synchronization with the two-dimensional scanning mechanism 4, processes a sample image only of a certain specific height of the sample 7, optically slices the sample 7, and obtains a confocal image to display the image in the monitor 14. Moreover, the process control unit 11 displays an operation screen for obtaining the height information of the sample 7 together with this confocal image in the monitor 14. Here, the user observes the confocal image on the screen of the monitor 14, performs an operation on the operation screen on the monitor screen, and moves the Z-stage 12 in the optical axis direction to set a measurement range. This measurement range is stored in a memory in the process control unit 11.

Next, on receiving a user's operation, as shown in FIG. 4, the process control unit 11 displays a setting screen for performing the selection of the magnification (e.g., 10 times, 20 times, 50 times, 100 times) of the objective lens 5 and the selection of the measurement mode (e.g., the high-speed mode, the fine mode) on the screen of the monitor 14.

Here, by the user's operation on the setting screen, the magnification (e.g., 10 times) of the objective lens 5 for use in measuring the height information of the sample 7 is selected, and subsequently the measurement mode (e.g., the high-speed mode) is selected. It is to be noted that the setting of the magnification of the objective lens 5 is not limited to the operation on the setting screen shown in FIG. 6. For example, when the magnification of the objective lens 5 is already set, for example, on the microscope setting screen, the magnification does not have to be selected/set on this setting screen again.

The setting of the magnification of the objective lens 5 and the measurement mode is completed, and the measuring of the height information of the sample 7 is started. First, the height information calculation unit 32 reads the measurement condition data corresponding to the measurement mode (high-speed mode) at the magnification (10 times) of the objective lens 5, that is, the two-dimensional curved line which is an approximate curved line, three points which correspond to the number of the calculation points, and 10 μm which is the movement pitch ΔZ from the measurement condition data memory 31 shown in FIG. 5 in the set measurement range, and moves the Z-stage 12 in the optical axis direction in accordance with the movement pitch ΔZ (=10 μm).

Next, the height information calculation unit 32 takes in the output of the photodetector 10 every time the Z-stage 12 moves in the optical axis direction by the movement pitch ΔZ (=10 μm), and acquires each confocal image for each movement pitch ΔZ (ΔZf, ΔZb, etc.). At this time, the light intensity information of a certain point is, for example, a value of a black circle on the I-Z curve shown in FIG. 2.

Next, when the high-speed mode is set, the height information calculation unit 32 compares the light intensity information successively taken in for each movement pitch ΔZ with the light intensity information already taken in and maximized. As a result of the comparison, the light intensity information having a high light intensity is changed as maximum light intensity information. This comparison operation is successively repeatedly performed every time the light intensity information is taken in and, as a result, the light intensity information indicating a maximum light intensity is obtained. At this time, height information Z(m) of the Z-stage 12, and maximum light intensity Imax are acquired.

Moreover, the height information calculation unit 32 extracts height information of the Z-stage 12 in heights Z(m)−ΔZ, Z(m)+AZ before/after the height information Z(m) indicating the maximum light intensity, and light intensity information {Z(m)−ΔZ, I′}, {Z(m)+ΔZ, I″} from successively taken-in light intensity information.

Next, the height information calculation unit 32 selects a secondary curved line as the approximate curved line from the measurement condition data memory 31 shown in FIG. 4, and sets this secondary curved line, for example, as follows:
I=a·Z²+b·Z+c (1)
Moreover, the height information calculation unit 32 substitutes the previously extracted height information of the Z-stage 12 and the light intensity information {Z(m), Imax}, {Z(m)−ΔZ, I′} into equation (1) to obtain the following:
a=(I′+I″−2Imax)/2 (2); and
b=(I″−I′)/2 (3), and
obtains values (Z₀, I) of a vertex of the secondary curved line as follows:
Z₀=−b/(2a) (4); and
I=Imax−b²/4a (5).
Accordingly, it is possible to obtain the luminance of the surface of the sample 7 and the relative height with a resolution which is not less than the movement pitch ΔZ.

On the other hand, when the fine mode is set, the height information calculation unit 32 similarly successively compares the respective successively taken-in light intensity information for each movement pitch ΔZ, obtains the light intensity information indicating the maximum light intensity, and acquires the height information Z(m) of the Z-stage 12 and the maximum light intensity Imax.

Moreover, the height information calculation unit 21 extracts the respective height information of the Z-stage 12 in heights Z(m−2)·ΔZ, Z(m)−ΔZ, Z(m)+ΔZ, Z(m+2)·ΔZ every two points before/after the height information Z(m) indicating the maximum light intensity, and light intensity information {Z(m−2)·ΔZ, I′}, {Z(m)−ΔZ, I′}, {Z(m)+ΔZ, I″}, {Z(m+2)·ΔZ, I″} from successively taken-in light intensity information.

Next, the height information calculation unit 32 selects a gauss curved line as the approximate curved line from the measurement condition data memory 31 shown in FIG. 4. As to the gauss curved line, the I-Z curve can be approximated with higher precision as compared with the secondary curved line.

The gauss curved line is assumed, for example, as follows:
I=A·exp{−(Z−Z₀)²/2W²} (6).
Since this gauss curved line I can be represented by the following:
logI=aZ²+bZ+c (7),
the height information calculation unit 32 substitutes the height information of already extracted five points and light intensity information {Z(m−2)·ΔZ, I′}, {Z(m)−ΔZ, I′}, {Z(m)+ΔZ, I″}, {Z(m+2)·ΔZ, I″} to obtain (a, b, c) by a minimum square law, and further obtains values (Z0, I) of the vertex of the gauss curved line:
Z₀=−b/(2a) (8); and
I=exp{c−b²/4a} (9).

Accordingly, it is possible to obtain the luminance of the surface of the sample 7 and the relative height with a resolution which is not less than the movement pitch ΔZ. In this case, since the number of the calculation points is five points, and the approximate curved line is the gauss curved line in the fine mode, the height information of the sample 7 can be obtained with a higher precision.

Thus, in the third embodiment, the Z-stage 12 is moved every movement pitch ΔZ in accordance with the measurement condition data of the light intensity information in accordance with each measurement mode which is the high-speed mode or the fine mode to acquire the magnification of the objective lens 5 and the height information of the sample 7, and the maximum light intensity information is obtained based on each light intensity information every calculation points acquired in a discrete manner for each movement pitch ΔZ. Since the height information of the sample 7 is acquired from the height of the Z-stage 12 corresponding to the maximum light intensity information, the light intensity information and the height information of the sample 7 can be measured at a high speed while reducing the number of the movements of the Z-stage 12.

Additionally, the user can select the magnification (e.g., 10 times, 20 times, 50 times, 100 times) of the objective lens 5 and the measurement mode (e.g., the high-speed mode, the fine mode) as required for the measurement, and can measure the light intensity information and the height information of the sample 7 on measurement conditions optimum for the magnification of the objective lens 5 and the measurement mode, that is, the approximate curved line, the number of the calculation points, and the movement pitch.

Moreover, it is possible to obtain the luminance of the surface of the sample 7 and the relative height with a resolution which is not less than the movement pitch ΔZ, the light intensity information and the height information of the sample 7 can be further measured by the high-speed mode in a short time, and the height information of the sample 7 can be obtained by the fine mode with the high precision.

Moreover, when the magnification and the measurement mode of the objective lens 5 are set on the setting screen shown in FIG. 6, the light intensity information and the height information of the sample 7 can be automatically measured on the measurement conditions optimum for the magnification of the objective lens 5 and the measurement mode as desired by the user.

Moreover, in the third embodiment, the high-speed mode and the fine mode can be selected/set as the measurement mode, but this is not limited, and an intermediate mode between the high-speed mode and the fine mode, or various modes for measuring the height information of the sample 7 may be selected/set. As the approximate curved line, another curved line may be used besides the secondary curved line and the gauss curved line, and the number of the calculation points may be set otherwise, and variously changed in accordance with the characteristics of the confocal microscope.

Furthermore, the confocal microscope is not limited to the constitution shown in FIG. 4 and, for example, an XY stage which moves the sample 7 in a plane vertical to the optical axis may be used as a scanning mechanism which relatively scans the convergent light along the surface of the sample 7 by the objective lens 5. Moreover, the convergent light of the objective lens 5 may be scanned every line on the sample 7 by a one-dimensional scanner instead of the two-dimensional scanning mechanism 4, and the sectional shape of the sample 7 may be measured. As a moving mechanism which moves the relative position between the condensing position of the objective lens 5 and the position of the sample 7, instead of the movement by the Z-stage 12, for example, a mechanism which moves the objective lens 5 may be used, or the objective lens 5 and the sample 7 may be moved with respect to each other.

Moreover, instead of the confocal diaphragm 9, for example, a Nipkow disk in which a plurality of micro holes are spirally disposed in a disc may be rotated at high speed. This Nipkow disk also serves as the micro holes disposed in a position conjugated with the condensing position of the objective lens 5, and a two-dimensional image sensor using, for example, a CCD or the like is used as the photodetector 10.

The confocal microscope is applicable to all inventions, as long as various confocal diaphragms 9 are disposed in positions conjugated with respect to the condensing position of the objective lens 5, the intensity information of the light passed through the confocal diaphragm at a time when the relative distance between the sample 7 and the objective lens 5 is relatively changed is acquired in the discrete manner, the relative distance to obtain the maximum light intensity information is estimated based on the light intensity information, and the relative distance is used as the height information of the sample 7.

According to this confocal microscope of the third embodiment, the height information can be obtained at a high speed on optimum measurement conditions.

Next, a system including a confocal microscope according to a fourth embodiment of the present invention will be described.

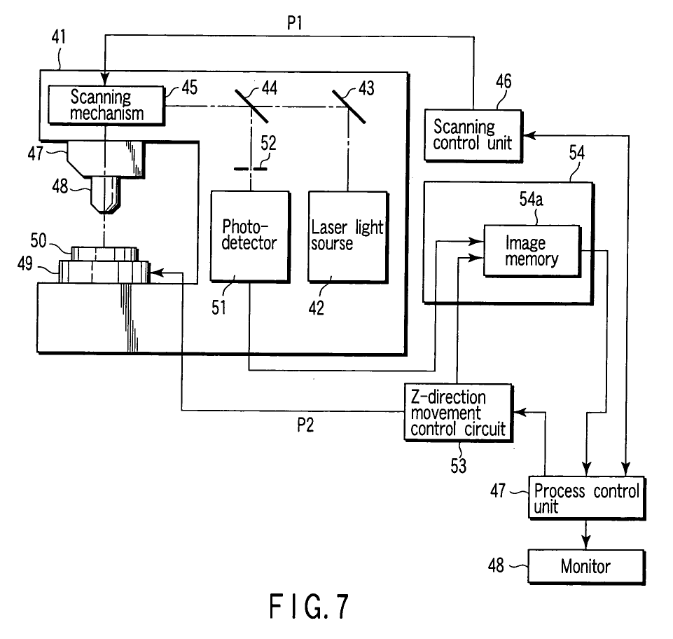

FIG. 7 is a diagram showing a schematic constitution of the system including the confocal microscope to be applied to a height measuring method in the fourth embodiment. In the system of the present embodiment, the sample is two-dimensionally scanned using an optical system of a confocal scanning type optical microscope to thereby acquire surface information.

A confocal microscope 41 shown in FIG. 7 reflects scanning laser light from a laser light source 42 by a mirror 43, and applies the light into a scanning mechanism 45 via a half mirror 44.

The scanning mechanism 45 is connected to a process control unit 47 constituted of a computer or the like via a scanning control unit 46, and is driven/controlled based on a scanning control signal P1 output from the scanning control unit 46 by an instruction from the process control unit 47.

This scanning mechanism 45 condenses and applies the scanning laser light as a micro spot onto a sample 50 on a stage 49 via an objective lens 48 set on a revolver 47 based on the scanning control signal P1, and scans the scanning laser light over the sample 50 in an XY direction in this state in the same manner as in raster scanning.

The reflected light reflected by the sample 50 when scanning the sample by the scanning laser light is guided to the half mirror 44 via the objective lens 48 and the scanning mechanism 45, and reflected on the side of a photodetector 51 by this half mirror 44.

The reflected light reflected by the half mirror 44 passes through a confocal diaphragm 52 disposed in a position conjugated with the condensing position of the objective lens 48, and thereafter enters the photodetector 51. The photodetector 51 converts the incident reflected light into an electric signal corresponding to quantity of light to output the signal to an image processing unit 54.

The image processing unit 54 contains an image memory 54a comprising, for example, 512 pixels×512 pixels×8 bits (256 gradations). The image memory 54a is connected to the photodetector 51, and stores the electric signal output from the photodetector 51. Furthermore, the image memory 54a is connected to a Z-direction movement control circuit 53 which moves/controls the stage 49 in the Z-direction (i.e., the optical axis direction of the scanning laser light) to scan the scanning laser light in the Z-direction. A counted value obtained by counting the number of the movements of the stage 49 based on the signal output from the Z-direction movement control circuit 53 is stored in the image memory 54a.

Moreover, the stage 49 is moved/controlled by a predetermined amount in the Z-direction based on a Z control signal P2 output from the Z-direction movement control circuit 53 by an instruction of the process control unit 47. At this time, a movement amount (movement pitch) of the stage 49 per movement is controlled by the process control unit 47.

Furthermore, the user sets a measurement range, the movement amount of the stage 49 in each measurement range, image display, and control of a microscope system, while seeing a setting screen displayed in a monitor 48 connected to the process control unit 47.

In the system constituted as described above, after the user lays the sample 50 on the stage 49, the micro spot condensed on the sample 50 is scanned in an XY direction by control by the process control unit 47. Moreover, simultaneously, the movement of the stage 49 is controlled in a Z-direction in each measurement point (x, y) to thereby control focusing with respect to the sample 50. At this time, it is judged whether or not the sample 50 is focused, while seeing the image displayed in the monitor 48.

Next, the user sets each parameter concerning a measurement operation. First, after setting a measurement range L of the sample 50 by the process control unit 47, and a position Z0 of the stage 49 to start the measurement, the user sets a movement pitch Δ (ΔZ) per movement of the stage 49 in Z scanning.

When setting the measurement range L and the movement pitch A per movement of the stage 49, movement times N of the stage 49 are determined in accordance with a relation of L/Δ≦N. Additionally, since the counted value of the movement times of the stage 49 is stored in the image memory 54a, the movement times N of the stage 49 are limited to a gradation number of 255 or less in the image memory 54a.

After setting the measurement range L, the movement pitch A, and the movement times N as described above, measurement with respect to the sample 50 is started, and then electric signals I₀, I₁, . . . , Iₙ in relative positions Z₀, Z₁, . . . , Zₙ of the Z-direction are detected by the photodetector 51.

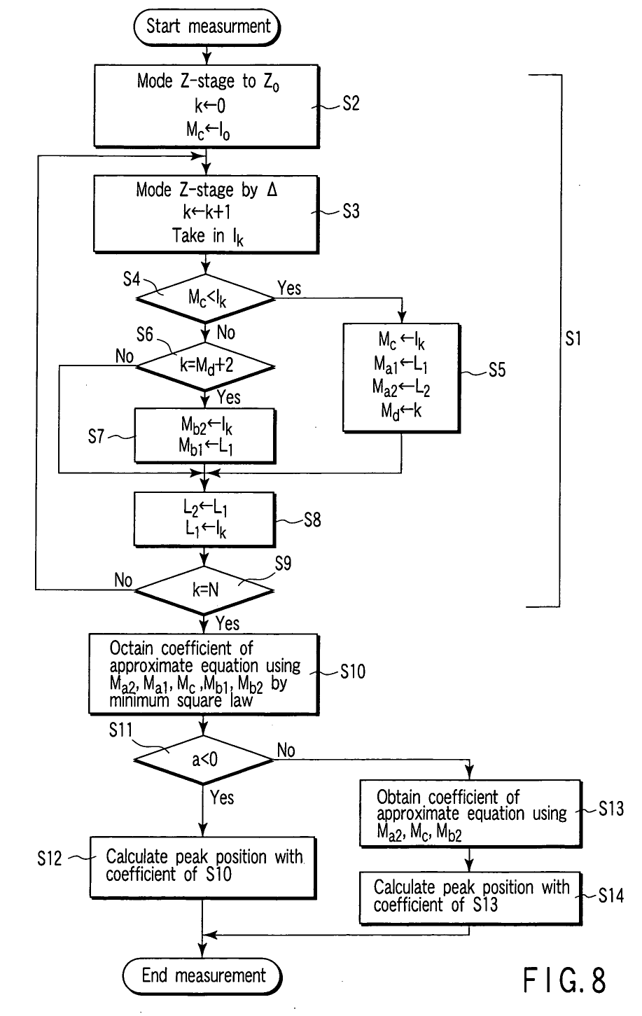

Next, the height measuring method in the confocal microscope constituted in this manner will be described with reference to a flowchart shown in FIG. 8.

First, Z-scanning is performed to sample luminance, and a maximum luminance value, luminance in five points in total before/after the maximum value, and a value of a Z counter at which the luminance is maximized are stored (step S1 (step S2 to step 9)). Concrete contents of the step S2 to step S9 are as follows.

Initialization at the time of measurement start is performed (step S2). As concrete initialization, after moving a Z-stage to Z₀, and resetting the counter (substitute 0 into k), an initial value I₀ of the luminance is taken in, and a value of I₀ is stored in a maximum luminance value M_{c}. Next, the Z-stage is moved by the movement pitch Δ, a counter value k is incremented, and further luminance Iₖ is taken in (step S3).

The luminance Iₖ is compared with the value of the maximum luminance value M_{c} (step S4). When Iₖ is larger than M_{c} (YES), Iₖ is stored in M_{c}, the previous luminance L₁ is stored in Mₐ₁, a luminance L2 before the previous luminance is stored in Mₐ₂, and k is stored in M_{d}, respectively (step S5), and the process shifts to (step S8). On the other hand, when Iₖ indicates a value that is not more than M_{c} in step S4 (NO), it is judged whether or not the value of the counter is k=M_{d}+2 (step S6). When k=M_{d}+2 in this judgment (YES), the luminance Iₖ is stored in M_{b2}, and L₁ is stored in M_{b1}, respectively (step S7), and the process shifts to step S8. On the other hand, when k=M_{d}+2 is not established in step S6 (NO), the process shifts to step S8 as such.

Next, in the step S8, the previous luminance L₁ is stored in the luminance L₂ before the previous luminance, and the luminance Iₖ is stored in the previous luminance L₁, respectively. Thereafter, it is judged whether or not the counter value reaches an end value N (step S9). When the values becomes equal (YES), the sampling of the luminance and the extracting of five points before/after the maximum value are completed. When the counter value does not reach the end value, the process returns to the step S3, and the same process is repeatedly performed.

When the sampling of the luminance ends, next the I-Z curve is approximated by a secondary equation using five data Mₐ₂, Mₐ₁, M_{c}, M_{b1}, M_{b2} before/after the maximum luminance. A coefficient of an approximate equation is calculated by a least-squares method. A magnitude of influence of noise is judged in accordance with a secondary coefficient a of the approximate equation obtained in this step S10 (step S11).

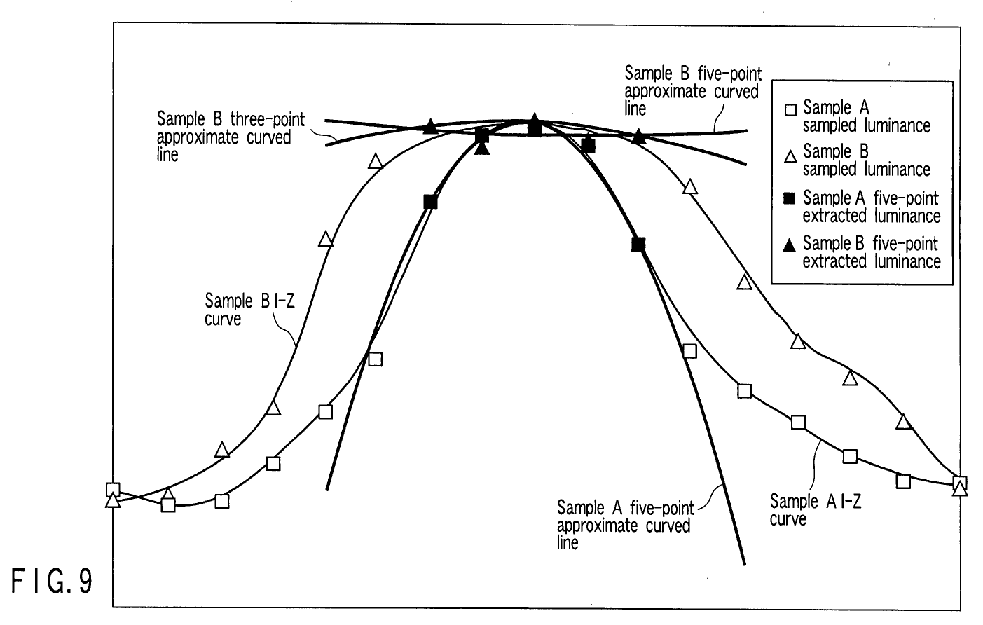

Here, the magnitude of the influence of the noise in this judgment will be described with reference to FIG. 9. It is to be noted that FIG. 9 shows that the surface of a sample A is smooth, and therefore the I-Z curve is sharp. Since the surface of a sample B is rough, the I-Z curve is moderate.

In the above-described step S11, the coefficient a obtained by the calculation is negative ((YES) in a case where a <0), a secondary curved line is convex upwards as shown by a five-point approximate curved line of the sample A in FIG. 9, and therefore the I-Z curve can be approximated. That is, it is judged that the influence of the noise is small, and a peak position is calculated using the coefficient obtained in step S10 (step S12). Additionally, when the coefficient a is not negative, and is positive in the judgment of the step S11 (NO), the curved line is convex downwards as in a five-point approximate curved line of the sample B. When 0, a straight line is obtained. In this case, the extracted five-point data indicates that the I-Z curve cannot be approximated by the influence of the noise.

Therefore, in this case, it is considered that a change of the luminance on the I-Z curve is small, and the influence of the noise is large. The coefficient of the approximate equation is calculated using Mₐ₂, M_{b2}, M_{c} without using data Mₐ₁, M_{b1} of points in the vicinity of the maximum value (step S13). In this case, the approximate curved line is obtained as shown by a three-point approximate curved line of the sample B, and the peak position is calculated based on this coefficient (step S14).

According to this method, even when a scanning range of Z is broad, data for six frames Mₐ₂, Mₐ₁, M_{c}, M_{b1}, M_{b2}, and M_{d} are stored, and the use of the memory can be reduced. It is to be noted that in the above description, a <0 (the approximate curved line is convex upwards) is set as a condition to judge the noise influence for simplicity of the description, but even when a <0 (convex upwards), the approximate curved line is sometimes excessively broadened. Therefore, a more appropriate threshold value (<0) is preferably used.

The coefficient a indicates a spread width of the I-Z curve, and is minimized in a case where the sample has a mirror surface (the width of the I-Z curve is narrowed). When the sample surface is rough, the I-Z curve spreads about twice, about ½ (<0) of the coefficient a in case of the mirror surface may be set. The coefficient a in case of the mirror surface may be obtained by actual measurement of the I-Z curve of the mirror surface, or by calculation from NA, wavelength and the like of an optical system.

Moreover, when there is not any noise, the peak position is calculated using a result of the step S10, and then the result necessarily indicates ±½ or less of the movement pitch Δ. Then, even the peak position is calculated in the step S10. When the peak position obtained by the calculation is in a range of ±½×Δ in the step S11, the peak position calculated in the step S10 is used in the step S12. In another case, the peak position may be obtained in a procedure of and after the step S13. It is to be noted that superposition of the noise upon the sampled luminance cannot be avoided, and therefore standard of the step S11 may be set to be slightly broad as ±Δ or ±2×Δ.

Moreover, when there is an allowance in the memory capacity of the image memory 54a, the luminance I₁, I₂, . . . , Iₙ are stored in the memory in all the positions of the Z scanning range in the step S4, and then the process of the step S5 to step S8 is not required.

In this case, the maximum value of the luminance and N points before/after the maximum value are extracted in the step S10, the number of extracted points may be three or more in this case, and the number is not limited to three or five points.

Furthermore, when it is evaluated in the step S11 that the influence of the noise is large (NO), in the step S13, the luminance data may be extracted again from five points before/after the maximum value every other point in the luminance degrees I₁, I₂, . . . , Iₙ in all the positions of the Z scanning range primarily stored in the step S4 instead of the luminance extracted in the step S10.

Thus, when the luminance degrees I₁, I₂, . . . , Iₙ in all the positions of the Z scanning range are stored in the memory, the process at the time of the sampling of the luminance (step S1) is reduced, the luminance can be sampled at a higher speed, and the number of the luminance degrees for use in the calculation of the peak position can be constant regardless of the magnitude of the influence of the noise. Therefore, a degree of freedom in the evaluation of the noise or the re-extraction of the luminance data increases.

According to the present embodiment, the following scopes are extracted.

The height measuring method of the fourth embodiment is a height measuring method using the confocal microscope. First, while changing the relative position between the sample and the objective lens at a predetermined interval, the luminance degrees in a plurality of positions are measured. Among a plurality of obtained luminance degrees, the influence of the noise is evaluated using the luminance data in at least three continuous positions before/after the maximum luminance. The approximate curved line is obtained, and the peak position of the luminance is calculated based on evaluation result of the noise.

In this height measuring method, to obtain the approximate curved line, when the influence of the noise is small, the approximate curved line is obtained using the luminance data in at least three continuous positions including the maximum luminance. When the influence of the noise is large, the approximate curved line is obtained using at least the luminance data excluding luminance data of positions adjacent to the position of the maximum luminance.

According to the height measuring method, when the approximate curved line is obtained, the width of the approximate equation is used as an evaluation standard of the noise. Moreover, the approximate curved line is calculated again using three points of center and opposite ends among the extracted five points.

Therefore, according to the fourth embodiment, even when the shape of the I-Z curve changes by the surface shape of the sample, the coefficient of the approximate equation of the I-Z curve is calculated without changing the step of Z or increasing the number of I for use in the calculation of the coefficient of the approximate equation, while suppressing the influence of the noise. Accordingly, the height can be correctly measured at a high speed.

Next, a fifth embodiment will be described.

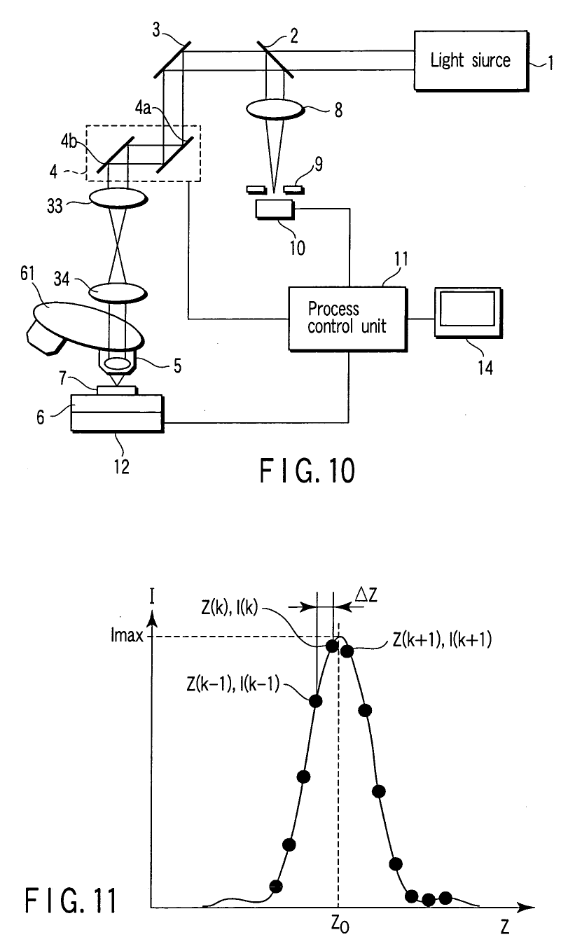

FIG. 10 shows a constitution example of the system including the confocal microscope according to a fifth embodiment of the present invention. In this system, constituting portions equivalent to those shown in FIG. 1 are denoted with the same reference numerals, and description thereof is omitted.

In this constitution, a plurality of objective lenses 5 having different magnifications are attached to a revolver 61. A process control unit 11 comprises a CPU, ROM, RAM and the like, and the CPU reads and executes a microscope control program stored in the ROM.

A luminance and height measurement process by this system will be described.

The condensing position by the objective lens 5 is in a position optically conjugated with a confocal diaphragm 9. When a sample 7 is in the condensing position by the objective lens 5, the reflected light from the sample 7 is condensed on the confocal diaphragm 9, and passes through the confocal diaphragm 9. However, when the sample 7 is in a position shifting from the condensing position by the objective lens 5, the reflected light from the sample 7 is not condensed on the confocal diaphragm 9, and does not pass through the confocal diaphragm 9.

FIG. 11 is a diagram showing a relation (I-Z curve) between a relative position (Z) of the condensing position of the objective lens 5 at this time with respect to the sample 7, and an output (I) of a photodetector 10.

As shown, when the sample 7 is in a condensing position Zo of the objective lens 5, the output of the photodetector 10 is maximum (Imax). As the relative position between the condensing position of the objective lens 5, and the sample 7 is distant from this position, the output of the photodetector 10 rapidly drops.

For example, when the output of the photodetector 10 acquired with respect to a predetermined point on the surface of the sample 7 indicates a value shown by a black circle of FIG. 11, an approximate secondary curved line passing through three points including a point (Z(k), I(k)) at which the output is maximum, and points (Z(k−1), I(k−1)), (Z(k+1), I(k+1)) before/after the maximum value is obtained.

Subsequently, the maximum light intensity value at which the output of the photodetector 10 is originally maximized, and a Z-position of a Z-stage 12 which gives the value are estimated from the obtained approximate secondary curved line, and the estimated maximum light intensity value and the Z-position which gives the value are acquired as luminance (luminance information) and height (height information).

According to the example shown in FIG. 11, a maximum light intensity Imax and a position Zo of the Z-stage 12 which gives the intensity are estimated from the obtained approximate secondary curved line, and the estimated Imax and Zo are acquired as the luminance and height.

In this luminance and height measurement process according to the fifth embodiment, the following process is also performed in addition to the measurement process in the above-described embodiment in order to prevent a wrong luminance and height from being acquired in a case where an inappropriate approximate secondary curved line is obtained.

When the outputs of the photodetector 10 are extracted in three Z-positions, and when the value of the output of the photodetector 10 is an inappropriate value in obtained the approximate secondary curved line, the approximate secondary curved line is not obtained, or the maximum light intensity value or the Z-position which gives the value are not estimated from the approximate secondary curved line. Instead, an arbitrary maximum light intensity value and an arbitrary Z-position are acquired as the luminance and height, or another process is performed.

Concretely, the process is performed as follows. Additionally, in the fifth embodiment, a range in which the value of the output of the photodetector 10 can be taken is set to 0 to 4095 (12 bits), and the above-described inappropriate value is set to 0 or 4095. The above-described arbitrary maximum light intensity value is set to 0 which is a minimum light intensity value in the range that can be taken as the value of the output of the photodetector 10, and an arbitrary Z-position is set to 0 which is a minimum value of a measurement range of a height direction for description.

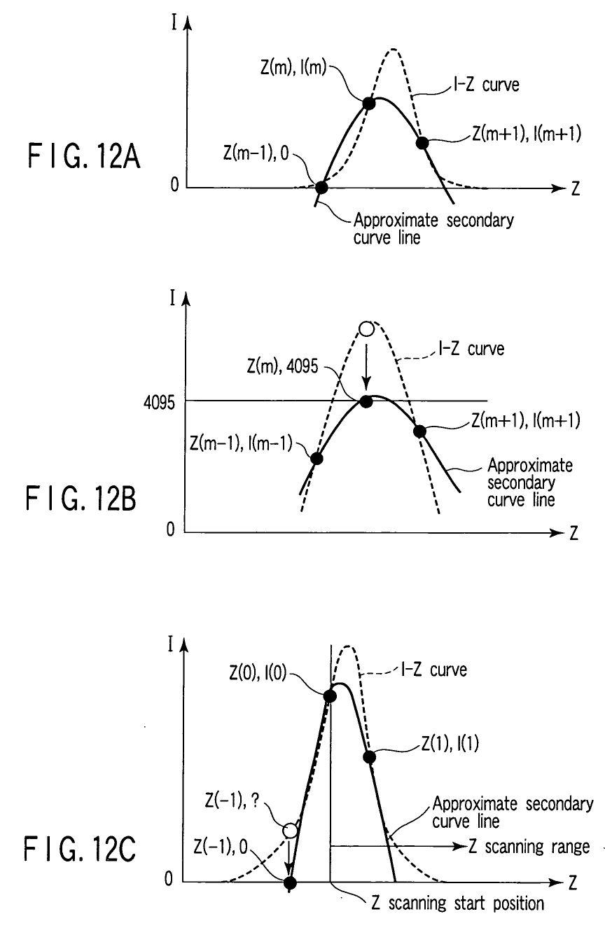

First, a process to be performed in a case where any of the outputs of the photodetector 10 in three extracted Z-positions is 0 will be described in accordance with an example of FIG. 12A.

FIG. 12A is a diagram showing one example of the output of the photodetector 10 in three extracted Z-positions. The example is obtained in a case where the setting of measurement conditions is inappropriate and therefore the output of the photodetector 10 is reduced, or reflectance of the measurement point on the surface of the sample 7 is low as compared with another case.

As shown in FIG. 12A, the output of the photo-detector 10 is hardly obtained over the measurement range of the Z-direction, and a slight output is obtained in the vicinity of a focal position (position where the condensing position of the objective lens 5 is on the surface of the sample 7). In this case, when points indicating the values of the outputs of the photodetector 10 in three Z-positions shown by black circles are extracted, (Z(m), I(m)), (Z(m−1), 0), (Z(m+1), I(m+1)) result. The approximate secondary curved line (solid line of FIG. 12A) obtained based on these values is largely different from an actual I-Z curve (dotted line of FIG. 12A), and a correct maximum light intensity value and a Z-position which gives the value cannot be estimated in some case.

Then, when any of the outputs of the photodetector 10 in the three extracted Z-positions is 0, the approximate secondary curved line is not obtained, or the maximum light intensity value or the Z-position giving this value is not estimated from the approximate secondary curved line, and the process is performed in such a manner as to acquire 0 as the luminance and height.

Next, with reference to FIG. 12B, an example of a process to be performed will be described in a case where any of the outputs of the photodetector 10 in the above-described three Z-positions is saturated, and the value is 4095. Contrary to the example shown in FIG. 12A, this example is obtained in a case where the output of the photodetector 10 is large, or the reflectance of the measurement point on the surface of the sample 7 is high as compared with the other case. In this case, one value (white circle of FIG. 12B) exceeding the measurement range of the photodetector 10 among the outputs of the photodetector 10 in the three extracted Z-positions is replaced with 4095 which is an upper limit value of the measurement range.

Therefore, when points indicating the values of the outputs of the photodetector 10 in three Z-positions shown by black circles including this value are extracted, (Z(m), 4095), (Z(m−1), I(m−1)), (Z(m+1), I(m+1)) result. The approximate secondary curved line (solid line of FIG. 12B) obtained based on these values is largely different from an actual I-Z curve (dotted line of FIG. 12B), and a correct maximum light intensity value and a Z-position which gives the value cannot be estimated in some case. Then, to prevent this, when any of the outputs of the photodetector 10 in the three extracted Z-positions is 4095, the approximate secondary curved line is not obtained, or the maximum light intensity value or the Z-position giving this value is not estimated from the approximate secondary curved line, and the process is performed in such a manner as to acquire 0 as the luminance and height.

The process performed in a case where any of the outputs of the photodetector 10 in the three extracted Z-positions is 0 or 4095 as described above is performed with respect to the respective measurement points on the surface of the sample 7, and then an image is subsequently displayed in the monitor 14 based on the luminance and height obtained with respect to each measurement point.

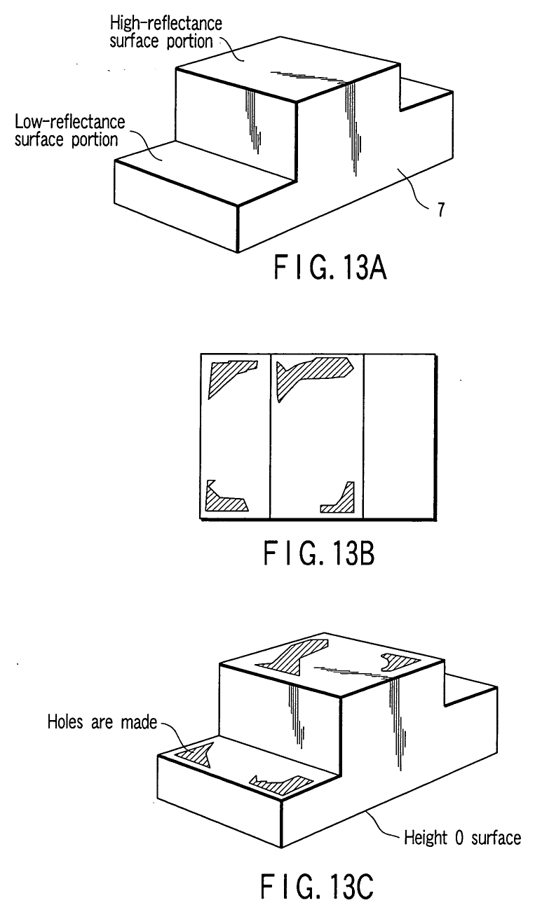

For example, when the shape of the sample 7 is a shape shown in FIG. 13A, an image shown in FIG. 13B or FIG. 13C or the like is displayed. FIG. 13A is a diagram showing one example of the shape of the sample 7. A part of the surface of the sample has a high-reflectance surface portion and a low-reflectance surface portion. FIG. 13B is a diagram showing one example of a luminance image (two-dimensional image) displayed based on acquired luminance. Portions shown in black in FIG. 13B indicate the portions having a luminance of 0. FIG. 13C is a diagram showing one example of a height image (three-dimensional image) displayed based on the acquired luminance and height. Portions shown in black in FIG. 13C indicate the portions whose luminance and height are 0, and in actual, hollow portions in which holes are made are displayed.

Thus, when the outputs of the photodetector 10 in three Z-positions for obtaining an approximate secondary curved line indicate inappropriate values, the measurement point whose luminance and height are 0 is visually distinguishably displayed in an image based on the luminance and height acquired with respect to each measurement point on the surface of the sample 7. Accordingly, the user can visually judge that any measurement point on the surface of the sample 7 indicates incorrect data, or any measurement point or measurement condition of a measurement object portion is inappropriate.

Next, another example in a case where any of the outputs of the photodetector 10 in the above-described three extracted Z-positions is 0 will be described in accordance with an example of FIG. 12C.

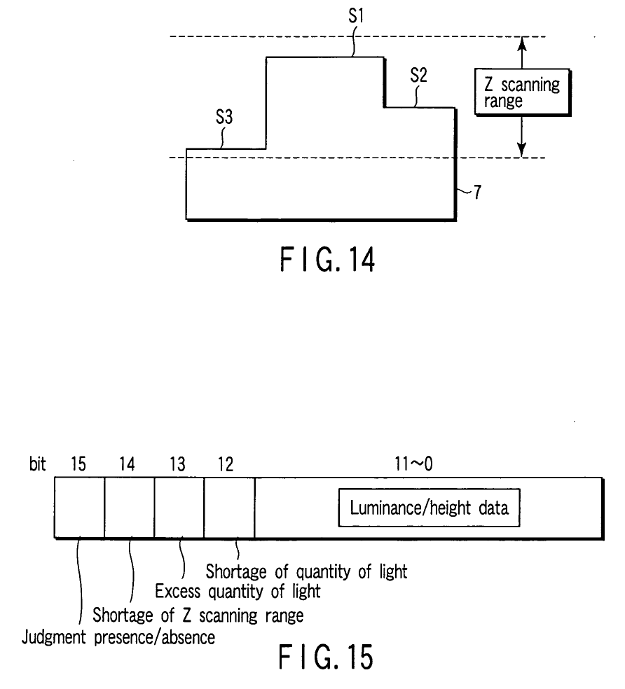

FIG. 12C is a diagram showing one example of the outputs of the photodetector 10 in the three extracted Z-positions. The example shown in FIG. 12C is an example in which, as shown in FIG. 14, a Z scanning range of FIG. 14 is set as the measurement range of the Z-direction by the user and, as a result, an S3 surface on the surface of the sample 7 is in the vicinity of a lower limit position of the measurement range. In this case, in a predetermined measurement point on the S3 surface, as shown in FIG. 12C, one of light intensity information in three Z-positions to be extracted cannot be acquired in some case. In the example of FIG. 12C, since the output of the photodetector 10 is maximized in a measurement start position of the Z-direction, the output of the photodetector 10 cannot be acquired in the previous Z-position. Therefore, even if the output of the photodetector 10 in the Z-position indicates a value shown by a white circle of FIG. 12C, the output cannot be actually acquired, and therefore the output of the photodetector 10 in the Z-position is regarded as 0 shown by a black circle. Therefore, when any of the outputs of the photodetector 10 in the three extracted Z-positions is 0, the approximate secondary curved line is not obtained, or the maximum light intensity value or the Z-position giving this value is not estimated from the approximate secondary curved line, and the process is performed in such a manner as to acquire 0 as the luminance and height.

When this process is performed with respect to each measurement point on the surface of the sample 7, an image based on the luminance and height obtained with respect to each measurement point is subsequently displayed in the monitor 14.

For example, an image shown in FIG. 13B is displayed.

In FIG. 13B, contrary to the example acquired or shown in FIG. 12C, the measurement range of the Z-direction is set by the user. As a result, since an S1 surface on the surface of the sample 7 shown in FIG. 14 is in the vicinity of an upper limit position of the measurement range, one of the outputs of the photo-detector 10 in three Z-positions for obtaining the approximate secondary curved line cannot be acquired in a predetermined measurement point on the S1 surface. The process is similarly performed even in this case.

Thus, the outputs of the photodetector 10 in the three Z-positions for obtaining the approximate secondary curved line indicate inappropriate values depending on the measurement range of the Z-direction set by the user in some case. In this case, the measurement point whose luminance and height are 0 is visually distinguishably displayed in an image based on the luminance and height acquired with respect to each measurement point on the surface of the sample 7. Accordingly, the user can visually judge that any measurement point on the surface of the sample 7 indicates incorrect data, or any measurement point or measurement condition of a measurement object portion is inappropriate. As described above, according to the fifth embodiment, since the approximate secondary curved line regarded as the I-Z curve is obtained, and the luminance and height of the sample 7 can be measured, the number of movement times of the Z-stage 12 is reduced, and the process can be accelerated in the measurement.

Moreover, when the values of the outputs of the photodetector 10 in the three Z-positions indicate a minimum value (e.g., 0) or a maximum value (e.g., 4095) in a range that can be taken by the output of the photodetector 10, the values are inappropriate in obtaining the approximate secondary curved line. When the inappropriate values result in this manner, the approximate secondary curved line is not obtained, or the maximum light intensity value or the Z-position giving this value is not estimated from the approximate secondary curved line, and the luminance and height are replaced with a specific value (e.g., 0).

Therefore, in the present embodiment, when a luminance image or a height image is displayed, a correct/incorrect measurement result can be distinguishably notified to the user, and it can be further notified whether or not appropriate measurement conditions have been set.

Next, a sixth embodiment according to the present invention will be described.

A constitution of a system including a confocal microscope according to the sixth embodiment is similar to that shown in FIG. 10 in the above-described fifth embodiment, but is different in a data format in digital-processing the output of a photodetector 10 by a process control unit 11.

FIG. 15 is a diagram showing one example of the data format according to the present embodiment. In this data format, a data length comprises, for example, 16 bits, data of 12 bits of bit numbers 0 to 11 indicate information on the luminance and height (luminance/height data), and data of four bits of the remaining bit numbers 12 to 15 indicate a condition flag (supplementary information).

The condition flag is a flag for notifying reasons why an inappropriate value has been obtained at a time when it is judged that any of the outputs of the photodetector 10 in three Z-positions extracted in order to obtain an approximate secondary curved line is the inappropriate value.

Here, in the example shown in FIG. 15, first the bit having bit number 15 indicates a flag indicating presence/absence of the judgment. The bit having bit number 14 indicates a flag indicating a shortage of a measurement range (shortage of a Z scanning range) of a Z-direction as the reason. The bit having bit number 13 indicates a flag indicating an excess quantity of light as the reason. The bit having bit number 12 indicates a flag indicating a shortage of quantity of light as the reason.

In a luminance and height measurement process according to the present embodiment, even when there is an inappropriate value in the outputs in three Z-positions as described above, the approximate secondary curved line is obtained. The maximum light intensity value and the Z-position which gives the value are estimated from this approximate secondary curved line, and the estimated maximum light intensity value and the Z-position from which the intensity value is obtained are acquired as the luminance and height.

That is, when the luminance and height measurement process of the sample 7 is started, in the same manner as in the fifth embodiment, the approximate secondary curved line is obtained, and the luminance and height are acquired with respect to each measurement point on the surface of the sample 7.

For example, it is judged that any of the outputs of the photodetector 10 in three Z-positions extracted in order to obtain the approximate secondary curved line is an inappropriate value with respect to a certain measurement point being processed because of the shortage of quantity of light. At this time, the above-described flags having the bit numbers 15 and 12 are raised, and information indicating that the information on the luminance and height is data obtained by the inappropriate approximate secondary curved line because of the shortage of quantity of light is recorded together with the information on the luminance and height.

Alternatively, it is judged that any of the outputs of the photodetector 10 in three Z-positions extracted in order to obtain the approximate secondary curved line is an inappropriate value with respect to a certain measurement point being processed because of the excess quantity of light. At this time, the above-described flags having the bit numbers 15 and 13 are raised, and information indicating that the information on the luminance and height is data obtained by the inappropriate approximate secondary curved line because of the excess quantity of light is recorded together with the information on the luminance and height.

Alternatively, it is judged that any of the outputs of the photodetector 10 in three Z-positions extracted in order to obtain the approximate secondary curved line is an inappropriate value with respect to a certain measurement point being processed because of the shortage of the measurement range of the Z-direction. At this time, the above-described flags having the bit numbers 15 and 14 are raised, and information indicating that the information on the luminance and height is data obtained by the inappropriate approximate secondary curved line because of the shortage of the measurement range of the Z-direction is recorded together with the information on the luminance and height.

When the above-described process is performed with respect to each measurement point on the surface of the sample 7, and the luminance and height of each measurement point are acquired, an image based on the luminance and height is subsequently displayed in the monitor 14.

Additionally, during this display, the process control unit 11 checks the flag of the bit having the bit number 15 in the above-described data of 16 bits with respect to each measurement point on the surface of the sample 7, checks each flag of the bit having the bit number 14 or 12 in data indicating that the flag is valid, and performs the display in accordance with the value of each flag.

For example, the measurement point in which the flag of the bit (shortage of quantity of light) having the bit number 12 is raised and 16-bit data is obtained is colored in blue, the measurement point in which the flag of the bit (excess quantity of light) having the bit number 13 is raised and 16-bit data is obtained is colored in red, the measurement point in which the flag of the bit (shortage of the measurement range of the Z-direction) having the bit number 14 is raised and 16-bit data is obtained is colored in yellow, and the points are displayed in the monitor 14.

FIGS. 16A, 16B show one example of an image displayed in accordance with the values of the flags of the bits having the bit numbers 12 to 14. FIG. 16A shows one example of a light intensity (two-dimensional image) displayed based on the luminance, and FIG. 16B shows one example of a height image (three-dimensional image) displayed in accordance with the luminance and height.

In FIGS. 16A, 16B, a region 63 (63a, 63b) colored in blue and displayed indicates the measurement point in which the flag of the bit (shortage of the quantity of light) having the bit number 12 has been raised and the 16-bit data has been obtained. A region 64 (64a, 64b, 64c) colored in red and displayed indicates the measurement point in which the flag of the bit (excess quantity of light) having the bit number 13 has been raised and the 16-bit data has been obtained. Furthermore, a region 62 (62a, 62b) colored in yellow and displayed indicates the measurement point in which the flag of the bit (shortage of the measurement range of the Z-direction) having the bit number 14 has been raised and the 16-bit data has been obtained. As described above, the region 63 indicates a region of the shortage of the quantity of light, the region 64 indicates a region of the excess quantity of light, and the region 62 indicates a region of the shortage of the measurement range of the Z-direction, respectively.

Thus, the measurement point from which low-reliability data (luminance and height) has been acquired is classified by color and colored, and accordingly the user can judge the reason why the low-reliability data has been acquired from the measurement point.

Moreover, besides the images shown in FIGS. 16A, 16B, a ratio of the measurement point colored in each color occupying the whole (ratio occupied by the pixel colored in the color in all the pixels) can be displayed in a constitution.

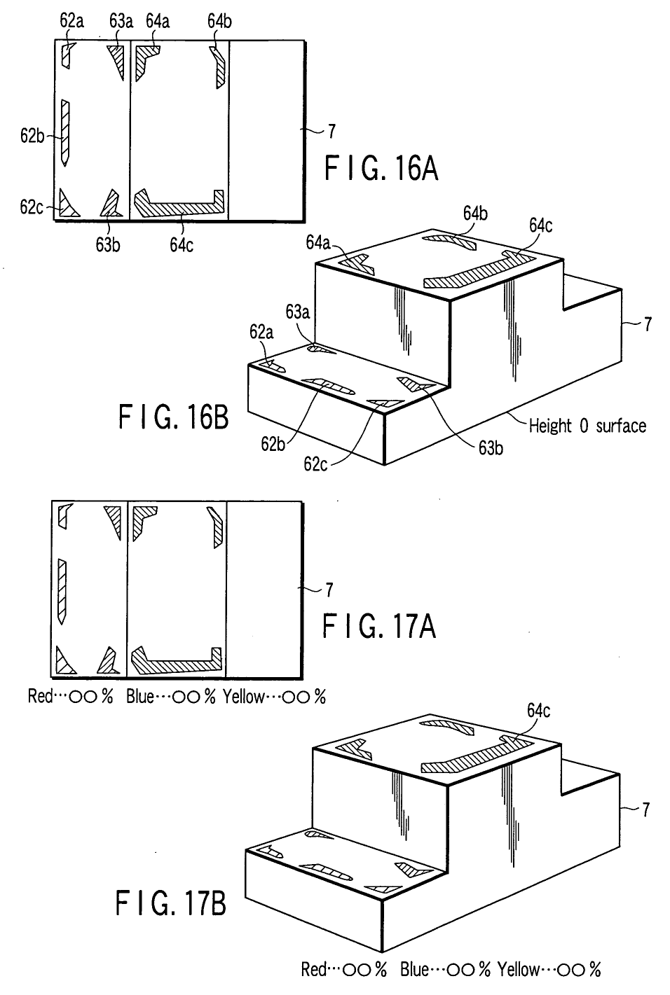

FIGS. 17A, 17B show one example of a display screen in which the display has been performed. FIGS. 17A, 17B correspond to FIGS. 16A, 16B. FIG. 17A is a diagram showing and displaying the luminance image shown in FIG. 16A together with occupying ratios of measurement points colored in colors in the whole. FIG. 17B is a diagram showing the height image shown in FIG. 16B together with occupying ratios of measurement points colored in colors in the whole.

As shown in FIGS. 17A, 17B, “red . . . ◯◯% blue . . . ΔΔ% yellow . . . xx%” is displayed under the image. Accordingly, the user can confirm that the data of the excess quantity of light occupies ◯◯% of the whole, the data of the shortage of the quantity of light occupies ΔΔ% of the whole, and the data of the shortage of the measurement range of the Z-direction occupies xx% of the whole. Instead of “red . . . ◯◯% blue . . . ΔΔ% yellow . . . xx%” displayed in FIGS. 17A, 17B, “excess quantity of light . . . ◯◯% shortage of quantity of light . . . ΔΔ% shortage of measurement range of Z-direction . . . xx%” or the like may be displayed.

Moreover, after the information on the luminance and height of each measurement point on the surface of the sample 7 is acquired in this manner, it is possible to measure a predetermined portion based on the acquired information on the luminance and height.

Additionally, when the information on the luminance and height is normally obtained, any problem does not occur, even if the luminance image or the height information shown in the monitor 14 includes the measurement point colored and displayed based on the above-described flags of the bits having the bit numbers 12 to 14. However, when the colored and displayed measurement point is included in a range selected as a portion constituting the measurement object, the measurement result of the measurement object portion is data having low reliability. In this case, when the measurement result is displayed, a mark for notifying that the measurement result is the low-reliability data is also displayed.

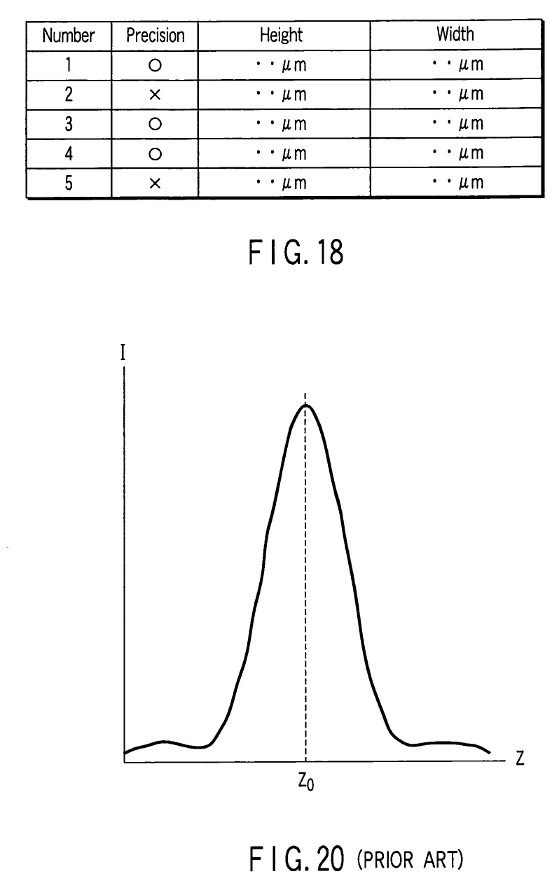

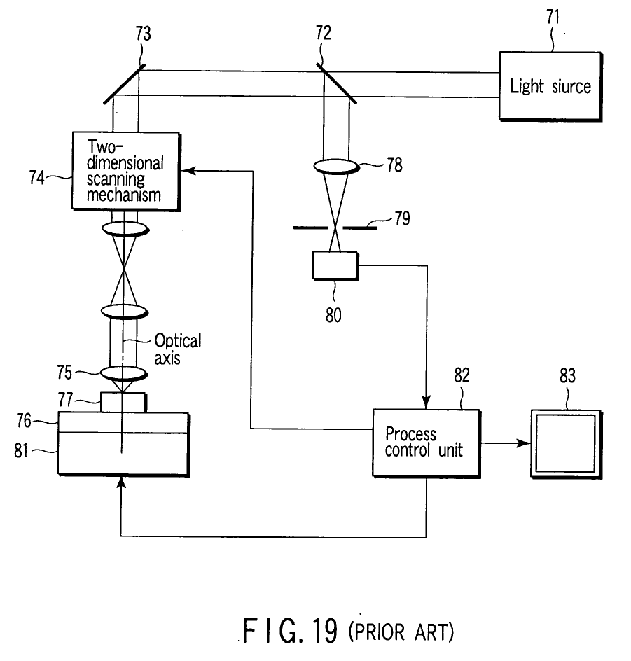

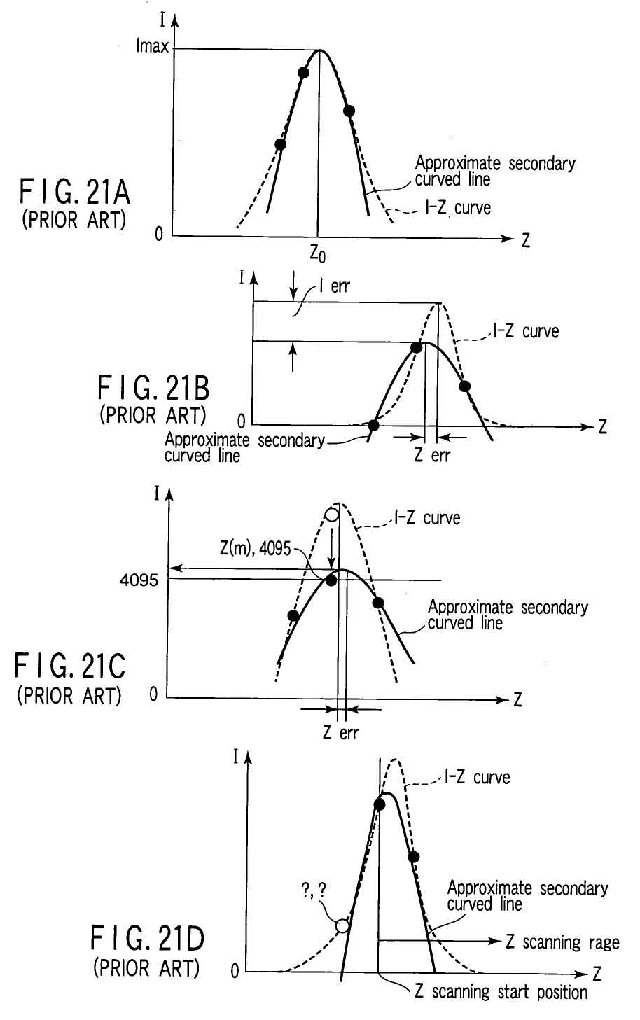

FIG. 18 is a diagram showing a display example of a prediction result.

In FIG. 18, “number” indicates measurement of a predetermined portion corresponding to the number. Moreover, “precision” is a mark indicating whether or not the measurement result is the low-reliability data. When the “precision” is “x”, the low-reliability data is indicated. When it is “◯”, it is indicated that the result is not the low-reliability data. Moreover, “height” and “width” indicate the height and width which are measurement results of the portion constitute the measurement object.

For example, in the measurement of the predetermined portion corresponding to the number 2 or 5, it is indicated that the measurement result is the low-reliability data because the colored and displayed measurement point is included in the portion selected as the measurement object portion.

Moreover, in this measurement process, to measure the predetermined portion based on the information on the acquired luminance and height, when the colored and displayed measurement point is included in the portion selected as the measurement object portion, the measurement is prohibited, a warning is displayed in the monitor 14, and this extent may be notified. Accordingly, a measurement result having a possibility of including a large error as compared with the measurement result of another measurement object portion can be prevented from being utilized by the user.

As described above, according to the present embodiment, since the luminance and height of the sample 7 are measured using the approximate secondary curved line, the movement times of the Z-stage 12 are reduced, and the process can be accelerated.

Moreover, when the output value of the photodetector 10 is an inappropriate value in obtaining the approximate secondary curved line, supplementary information (e.g., the above-described flags of the bits having the bit numbers 12 to 15) is imparted to the information on the luminance and height with respect to each measurement point. Accordingly, the user can be distinguishably notified of a correct/incorrect measurement result, and can be notified whether or not the appropriate measurement conditions have been set.

Next, modifications according to the above-described fifth, sixth embodiments will be described.

In the above-described fifth embodiment, the process has been performed in such a manner that the approximate secondary curved line is not obtained, or the maximum intensity value or the Z-position giving the value is not estimated from the approximate secondary curved line at a time when the three output values of the photodetector 10 for obtaining the approximate secondary curved line indicate the minimum value (e.g., 0) or the maximum value (e.g., 4095) of the range that can be taken by the output of the photodetector 10.

During this process, the output value of the photodetector 10 is not limited to the minimum value or the maximum value of the range, and may be a threshold value in which a noise content is considered. For example, when any of the three output values is not more than or not less than the threshold value, that is, the value is within a light intensity range of the minimum value to the threshold value of the range, or is included in the light intensity range of the maximum value to the threshold value, the process may be performed without obtaining the approximate secondary curved line, or without estimating the maximum intensity value or the Z-position giving the value from the approximate secondary curved line.

Moreover, in the fifth embodiment, when any of the values of the outputs of the photodetector 10 in three Z-positions extracted in order to obtain the approximate secondary curved line is an inappropriate value in obtaining the approximate secondary curved line, the luminance and height may be replaced with 0 which is a specific value, but the specific value is not limited to 0, and another value may be used.

Furthermore, the user indicates a pixel (measurement point) whose luminance and height are 0 on an image displayed based on the information on the luminance and height, applying the data format shown in FIG. 15 to the fifth embodiment, and accordingly the reasons (e.g., the shortage of the quantity of light) why the luminance and height of the image are 0 may be displayed.

In the sixth embodiment, information other than the information added to the information on the luminance and height and indicated by the bits of the bit numbers 12 to 15 may be added to the data format shown in FIG. 15. For example, when the flags of the bits having any of the bit numbers 12 to 14 and the bit number 15 are raised, information on an advice for eliminating the reason why the flag has been raised is added, and the added information on the advice may be displayed together with the image in the monitor 14.

In this case, for example, when the flags of the bits of the bit number 12 (shortage of the quantity of light) and 15 are raised, information advising that sensitivity of the photodetector 10 be increased is added as the information on the advise, and the advice is displayed together with the image in the monitor 14. Another help information or the like may be added.

Moreover, when the information other than the information added to the information on the luminance and height and indicated by the bits having the bit numbers 12 to 15 is added, and when the number of the bits for adding the information is lacking, the information may be buried in the information (the above-described 12-bit data having the bit numbers 0 to 11) on the luminance and height, using a known data compression technique. In this case, the information can be added without increasing the memory capacity.

Furthermore, in the sixth embodiment, when the flags of the bits of the bit numbers 12 to 15 are checked, the shortage of the quantity of light, the excess quantity of light, or the shortage of the measurement range of the Z-direction can be judged. An automatic control may be performed based on the judgment result in such a manner that the information on the luminance and height with respect to the measurement point judged in this manner is normally acquired. For example, the sensitivity of the photodetector 10 is set to an auto gain control (AGC) to re-acquire the information on the luminance and height, or the measurement range of the Z-direction set by the user is corrected to acquire the information on the luminance and height again.

Moreover, in the sixth embodiment, the process may be performed in such a manner as to acquire 0 as the luminance and height without obtaining the approximate secondary curved line or without estimating the maximum light intensity value or the Z-position giving the value from the approximate secondary curved line in the same manner as in the fifth embodiment at a time when any of the outputs of the photodetector 10 in three Z-positions extracted for obtaining the approximate secondary curved line is an inappropriate value.

Furthermore, in the fifth and sixth embodiments, the approximate secondary curved line has been obtained based on the outputs of the photodetector 10 in three Z-positions, but may be obtained based on the outputs of the photodetector 10 in three or more Z-positions.

Additionally, in the fifth and sixth embodiments, the system has been constituted as shown in FIG. 1, but the constitution is not limited to this, and another constitution may be used.

For example, an XY stage or the like which moves the sample 7 in a plane vertical to an optical axis may be used as a scanning mechanism which is a constitution of a confocal optical microscope included in the system and which relatively scans focused light by the objective lens 5 along the surface of the sample 7.

Moreover, a constitution in which a Nipkow disk having a plurality of micro openings spirally disposed in a disc is rotated at a high speed may be used. In this case, the Nipkow disk also serves as the micro holes disposed in a position conjugated with the condensing position of the objective lens 5, and a two-dimensional image sensor such as CCD is used instead of the photodetector 10.

Furthermore, instead of the two-dimensional scanning mechanism 3, a constitution may be used in which the focused light of the objective lens 5 is scanned over one line of the sample 7 by a one-dimensional scanner to measure a sectional shape of the sample 7.

Additionally, as the moving mechanism which relatively moves the condensing position of the objective lens 5 and the position of the sample 7, a mechanism which moves the position of the objective lens 5 may be used instead of the Z-stage 12 which moves the position of the sample 7.

Furthermore, the measuring unit 13 which directly detects the movement amount of the Z-stage 12 as described in the first embodiment can be easily applied even to the constitutions (FIG. 4, FIG. 7, and FIG. 10) of the other embodiments, and the relative position between the condensing position of the objective lens 5, and the sample 7 can be detected using the measuring unit 13. Therefore, in these other embodiments, the luminance and height dimension of the sample 7 are acquired based on the relative position information (movement information of the Z-stage 12) detected by the measuring unit 13, and the condensing position of the objective lens 5 and the position of the sample 7 do not have to be moved with high precision. Moreover, the movement times of the Z-stage 12 can be kept to be minimum, and rapid calculation is possible.

The confocal microscope of the present invention, and the measuring method by the confocal microscope have been described above in detail, but the present invention is not limited to described matters of the above-described embodiments of the present invention and, needless to say, various improvements and modifications may be performed in a range which does not depart from the scope of the present invention.

1. A confocal microscope comprising:
an objective lens which condenses and applies light from a light source with respect to a sample and which takes in reflected light from the sample;
a moving mechanism which relatively moves a condensing position of the objective lens and a position of the sample along an optical axis direction of the light;
a confocal diaphragm disposed in a position conjugated with the condensing position of the objective lens;
a photodetector which detects intensity of the light passing through the confocal diaphragm;
a measuring unit which detects a relative position between the condensing position of the objective lens, and the sample; and
a process control unit which changes the relative position between the condensing position of the objective lens, and the sample and which estimates a maximum value of a change curved line indicated by light intensity information and the relative position giving the value based on a plurality of pieces of light intensity information including a maximum light intensity value of the light intensity detected by the photodetector and position information detected by the measuring unit and which produces a confocal image using the estimated maximum value of the light intensity and the relative position as reflection luminance information and height information.

2. The confocal microscope according to claim 1, wherein the measuring unit is disposed on an optical axis of the objective lens.

3. The confocal microscope according to claim 1, further comprising: a height information calculation unit which has measurement condition data of the light intensity information in accordance with a magnification of the objective lens and each measurement mode to acquire the height information and which changes a relative distance between the sample and the objective lens in accordance with the measurement condition data to acquire the height information of the sample.

4. The confocal microscope according to claim 3, wherein the measurement condition data is an approximate curved line to estimate the height information from the light intensity information in accordance with the magnification of the objective lens and the measurement mode, the number of calculation points for use in extracting the light intensity information from the approximate curved line, and a movement pitch at a time when the relative distance is changed.

5. The confocal microscope according to claim 3, wherein the measurement condition data has time preferential data in which measurement time is given priority to measurement precision, and precision preferential data in which the measurement precision is given priority to the measurement time as the measurement mode.

6. A confocal microscope on which a height measuring device is mounted comprising:
a luminance measuring unit which changes a relative position between a sample and an objective lens at a predetermined interval while measuring luminance in a plurality of positions;
a noise evaluation unit which evaluates an influence of noise using luminance data in positions of at least three continuous points including a maximum luminance in measurement results of the luminance in the plurality of positions; and
a peak position estimation unit which obtains an approximate curved line to calculate a peak position of the luminance based on an evaluation result of the noise evaluation unit, the height measuring device measuring a height between the sample and the objective lens.

7. The confocal microscope on which the height measuring device is mounted according to claim 6, wherein to obtain the approximate curved line, the peak position estimation unit obtains the approximate curved line using the luminance data for use in the noise evaluation in a case where the influence of the noise is small, and
obtains the approximate curved line using at least the luminance data excluding the luminance data of a position adjacent to a position of the maximum luminance in the measured luminance data in a case where the influence of the noise is large.

8. The confocal microscope on which the height measuring device is mounted according to claim 7, wherein the peak position estimation unit measures the height using a width of the approximate curved line as an evaluation standard of the noise in a case where the approximate curved line is obtained.

9. The confocal microscope on which the height measuring device is mounted according to claim 7, wherein the peak position estimation unit performs re-calculation of the approximate curved line using three points of center and opposite ends among five extracted points.

10. The confocal microscope according to claim 1, further comprising:
an estimation unit which estimates a maximum light intensity value on a change curved line and the relative position giving the maximum light intensity value based on a plurality of pieces of light intensity information detected by the photodetector;
a second acquisition unit which acquires the maximum light intensity value and the relative position giving the maximum light intensity value estimated by the estimation unit as luminance information and height information, respectively;
a production unit which produces supplementary information based on the plurality of pieces of light intensity information estimated by the estimation unit; and
an adding unit which adds the supplementary information produced by the production unit to the luminance information and the height information acquired by the second acquisition unit.

11. The confocal microscope according to claim 10, wherein the estimation unit does not perform the estimating, and the second acquisition unit acquires an arbitrary light intensity value and an arbitrary relative position as the luminance information and the height information in a case where at least one or more of light intensity values indicated by the light intensity information detected by the photodetector indicates a predetermined light intensity value or belongs to a predetermined light intensity range.

12. The confocal microscope according to claim 10, wherein the supplementary information is displayed together with the maximum light intensity value and the relative position giving the maximum light intensity value estimated by the estimation unit and acquired as the luminance information and the height information by the second acquisition unit.

13. A confocal microscope comprising:
an objective lens;
a confocal diaphragm disposed in a position conjugated with a condensing position of the objective lens;
a photodetector which acquires light intensity information passed through the confocal diaphragm in a discrete manner at a time when a relative distance between the sample and the objective lens is changed;
a relative distance estimation unit which estimates the relative distance to obtain maximum light intensity information based on these light intensity information; and
a height information calculation unit which has measurement condition data of the light intensity information in accordance with each measurement mode to acquire a magnification of the objective lens and the height information and which changes the relative distance between the sample and the objective lens in accordance with the measurement condition data to acquire the height information of the sample.

14. The confocal microscope according to claim 13, wherein the measurement condition data is an approximate curved line to estimate the height information from the light intensity information in accordance with the magnification of the objective lens and the measurement mode, the number of calculation points for use in extracting the light intensity information from the approximate curved line, and a movement pitch at a time when the relative distance is changed.

15. The confocal microscope according to claim 13, wherein the measurement condition data has data in which measurement time is given priority, and data in which measurement precision is given priority as the measurement mode.

16. A height measuring method using a confocal scanning type optical microscope, the measuring method by a confocal microscope, comprising:
changing a relative position between a sample and an objective lens at a predetermined interval, while measuring luminance in a plurality of positions;
evaluating an influence of a noise using luminance data in positions of at least three continuous points including the maximum luminance among measurement results of the luminance in the plurality of positions; and
obtaining an approximate curved line to calculate a peak position of the luminance based on the evaluation results of the noise.

17. The measuring method by the confocal microscope according to claim 16, wherein the obtaining of the approximate curved line comprises:
obtaining the approximate curved line using the luminance data used in evaluating the noise in a case where the influence of the noise is small; and
obtaining the approximate curved line using at least luminance data from which luminance data of a position adjacent to a position of the maximum luminance has been excluded among the measured luminance data in a case where the influence of the noise is large.

18. The measuring method by the confocal microscope according to claim 17, wherein a width of the approximate curved line is used as an evaluation standard of the noise in a case where the approximate curved line is obtained.

19. The measuring method by the confocal microscope according to claim 17, wherein the re-calculating of the approximate curved line uses three points of center and opposite ends among five extracted points.
